(19) United States
(12) Patent Application Publication
(10) Pub. No.: US 2021/0262444 A1
(43) Pub. Date: Aug. 26, 2021

(54) WIND-POWERED ELECTRICAL GENERATION SYSTEM

(71) Applicants: Jerry L. Jenkins, Vernal, UT (US); Rayce L. Jenkins, Vernal, UT (US)

(72) Inventors: Jerry L. Jenkins, Vernal, UT (US); Rayce L. Jenkins, Vernal, UT (US)

(21) Appl. No.: 16/801,101

(22) Filed: Feb. 25, 2020

(51) Int. Cl. F03D 9/25; F03D 1/02; F03D 1/06

(52) U.S. Cl. CPC F03D 9/25; F03D 1/025; F05B 2240/30; F05B 2220/706; F03D 1/0633

(57) ABSTRACT

A wind-powered electrical generation system having a base, a first generator tower having a first generator bay, a second generator tower having a second generator bay and a wind tower. The wind tower includes one or more vents, each having a top wall, a bottom wall, a first sloped side wall, a second sloped side wall and a back opening. The sloped side walls are the external walls of the first and second generator towers. A turbine is positioned proximate to the back opening of the vent and is in mechanical communication with a first and second electrical generator. The first electrical generator is located inside the first generator bay and the second electrical generator is located inside the second generator bay. Two wind walls adjacent to the sloped side walls of the vent are also included.

### BACKGROUND

Traditional windmills have multiple blades mounted on a center shaft, the shaft is coupled to a gearbox, and the gearbox is coupled to a generator. The blades are turned at an angle to deflect the wind that comes in contact with them. The movement of the wind across the blades forces the shaft to rotate and the generator produces electricity. These windmills are less efficient than wind towers because they only harness the wind that comes in contact with the blades. The wind towers of the present invention are much more efficient than traditional windmills because they have side wind walls attached to one or more generator towers as well as vent structures that serve to funnel wind creating a wind induction effect. In particular, the orientation of the walls and the vents guides the wind into the lower half of the turbines while blocking the wind from the upper half of the turbines allowing them to rotate with less resistance. Funneling the wind creates a high-pressure area at the front of the wind tower, and a low-pressure area behind the wind tower resulting in the air being drawn through the turbines faster than the surrounding wind speed. In certain embodiments, a top wind wall can also be included that further aids in the wind funneling effect.

In larger embodiments, the wind towers are much more efficient than traditional windmills because they are essentially a wall made up of generator towers, vents and turbines. All of the wind that comes in contact with the wind tower is directed by the generator towers and vents into the lower half of the turbines while blocking the upper half of the turbines allowing them to rotate with less resistance.

### SUMMARY

A wind-powered electrical generation system is disclosed. The system includes a base, a first generator tower having at least one generator bay, a second generator tower having at least one generator bay and a wind tower. The wind tower includes one or more vents, each having a top wall, a bottom wall, a first sloped side wall, a second sloped side wall and a back opening. The sloped side walls are the external walls of the first and second generator towers. A turbine is positioned proximate to the back opening of the vent and is in mechanical communication with a first and second electrical generator. The first electrical generator is located inside the first generator bay and the second electrical generator is located inside the second generator bay. Two wind walls adjacent to the sloped side walls of the vent are also included.

In certain embodiments, a cap vent is also featured. The cap vent has a top wall, sloped side walls and a bottom wall. The cap vent top wall has a downward angular orientation. The cap vent can also include wind walls coupled to its sides. Base can include an inner base and an outer base. In certain embodiments, the inner base includes a cement pad; two base beams coupled to the cement pad; an upward oriented shaft positioned substantially at a central intersection point between the first and second base beams. Above the base beams are an upper side beam pivotally connected to the upward oriented shaft. An upper front beam can also be pivotally connected to the upward oriented shaft and above the base beams. Hydraulic rams connecting the upper side beams to the base beams allows the wind tower to be optimally positioned for receiving wind. Rollers such as casters can be included near the ends of the side beam as well as near the ends of the front and back upper beams such that actuation of the hydraulic rams cause the upper side beam to rotate around to the center shaft.

### BRIEF DESCRIPTION OF DRAWINGS

FIG. 1 features front views of various wind tower orientations according to certain embodiments of the present invention.

FIG. 2 is a front view of a wind-powered electrical generation system according to one embodiment of the present invention.

FIG. 3 is a side view of a wind-powered electrical generation system according to one embodiment of the present invention.

FIG. 4 is an elevated view of a generator bay according to one embodiment of the present invention.

FIG. 5 depicts a turbine according to one embodiment of the present invention.

FIG. 6 illustrates airflow and the resultant pressure differential across the turbines according to one embodiment of the present invention.

FIG. 7 illustrates airflow and the resultant pressure differential across the turbines according to one embodiment of the present invention.

FIG. 8 depicts an inner base structure according to one embodiment of the present invention.

FIGS. 9(a) and 9(b) depict side and front views respectively of a turtle deck according to one embodiment of the present invention.

FIGS. 10(a) and 10(b) depict top and side views respectively of an outer base according to one embodiment of the present invention.

FIGS. 11(a) and 11(b) depict top and side views respectively of an outer base equipped with a turtle deck according to one embodiment of the present invention.

FIG. 12 is a side view of a wind-powered electrical generation system according to one embodiment of the present invention.

FIG. 13 is a front view of a wind-powered electrical generation system according to one embodiment of the present invention.

FIG. 14 is a depiction of a guideline mount according to one embodiment of the present invention.

FIG. 15 is a depiction of system anchors according to one embodiment of the present invention.

FIG. 16 depicts front and side views of a wind-powered electrical generation system according to one embodiment of the present invention.

FIG. 17 is an illustration of an electronics shack according to one embodiment of the present invention.

FIG. 18 is an illustration of an electronics shack according to one embodiment of the present invention.

FIG. 19 is an illustration of electronics shack roof beams according to one embodiment of the present invention.

FIG. 20 depicts a base structure according to one embodiment of the present invention.

FIG. 21 depicts a caster assembly according to one embodiment of the present invention.

FIG. 22 is a side view of a wind-powered electrical generation system according to one embodiment of the present invention.

FIG. 23 is a front view of a wind-powered electrical generation system according to one embodiment of the present invention.

FIG. 24 depicts side and front views respectively of a turtle deck according to one embodiment of the present invention.

FIG. 25 is a front view of a wind-powered electrical generation system according to one embodiment of the present invention.

FIG. 26 is a side view of a wind-powered electrical generation system according to one embodiment of the present invention.

FIG. 27 is a rear view of a wind-powered electrical generation system according to one embodiment of the present invention.

FIG. 28 is an interior view of a generator bay according to one embodiment of the present invention.

FIG. 29 is a brake linkage system according to one embodiment of the present invention.

FIG. 30 is an illustration of an anchor system according to one embodiment of the present invention.

FIG. 31 is a schematic top view of a wind-powered electrical generation system illustrating the movement of wind through vents according to one embodiment of the present invention.

FIG. 32 is a front view of a wind-powered electrical generation system according to one embodiment of the present invention.

FIG. 33 is a side view of a wind-powered electrical generation system according to one embodiment of the present invention.

FIG. 34 is a rear view of a wind-powered electrical generation system according to one embodiment of the present invention.

FIG. 35 depicts an anchoring system according to one embodiment of the present invention.

FIG. 36 is a top view of a sway damper according to one embodiment of the present invention.

FIG. 37 is a front elevated view of a sway damper according to one embodiment of the present invention.

FIG. 38 is a perspective of a base structure with the cement ring removed for clarity.

FIG. 39 depicts a brake linkage system according to one embodiment of the present invention.

FIG. 40 is a front view of a wind-powered electrical generation system featuring a safety screen according to one embodiment of the present invention.

FIG. 41 is a broken front view of a wind-powered electrical generation system featuring a safety screen according to one embodiment of the present invention.

FIG. 42 is a photograph of a wind-powered electrical generation system according to one embodiment of the present invention.

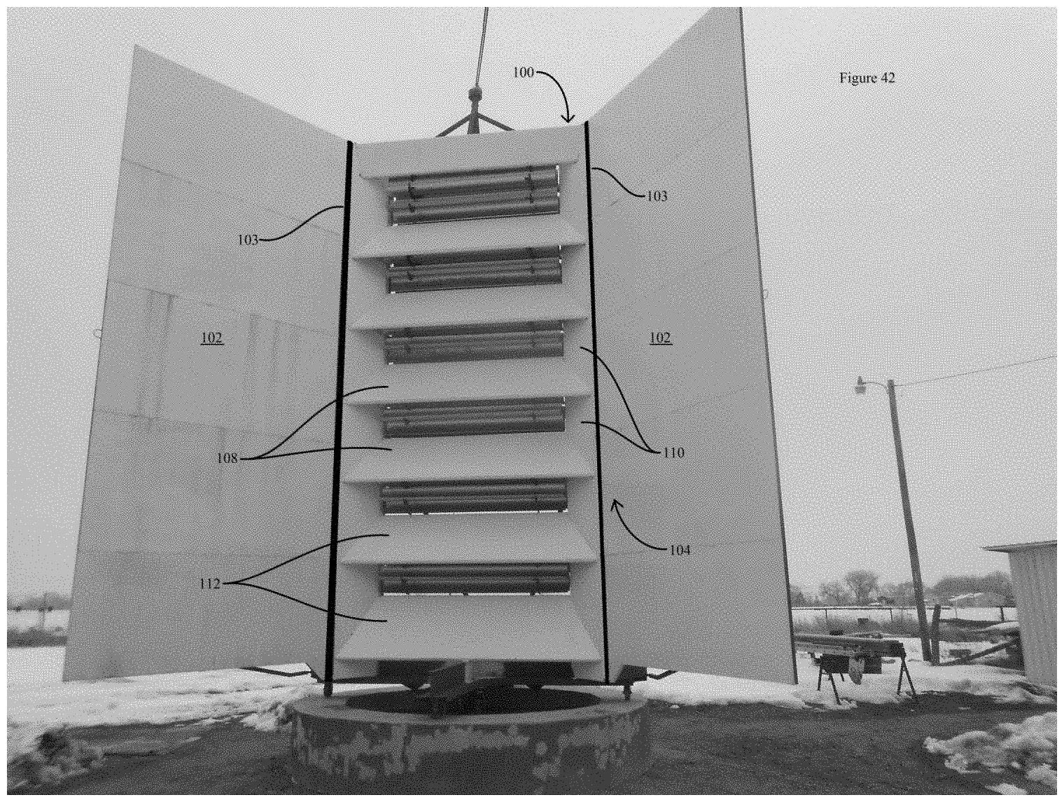

FIG. 43 is a photograph of a base structure in a wind-powered electrical generation system according to one embodiment of the present invention.

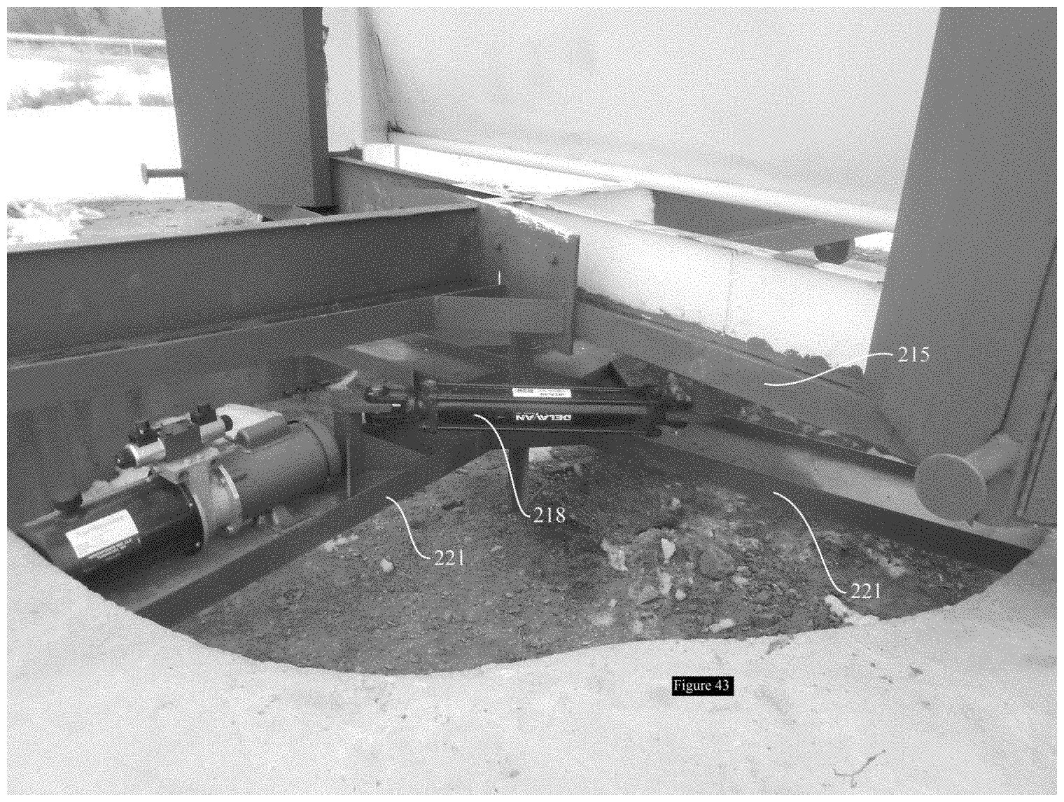

FIG. 44 is a front perspective view of a wind-powered electrical generation system according to one embodiment of the present invention.

### DETAILED DESCRIPTION

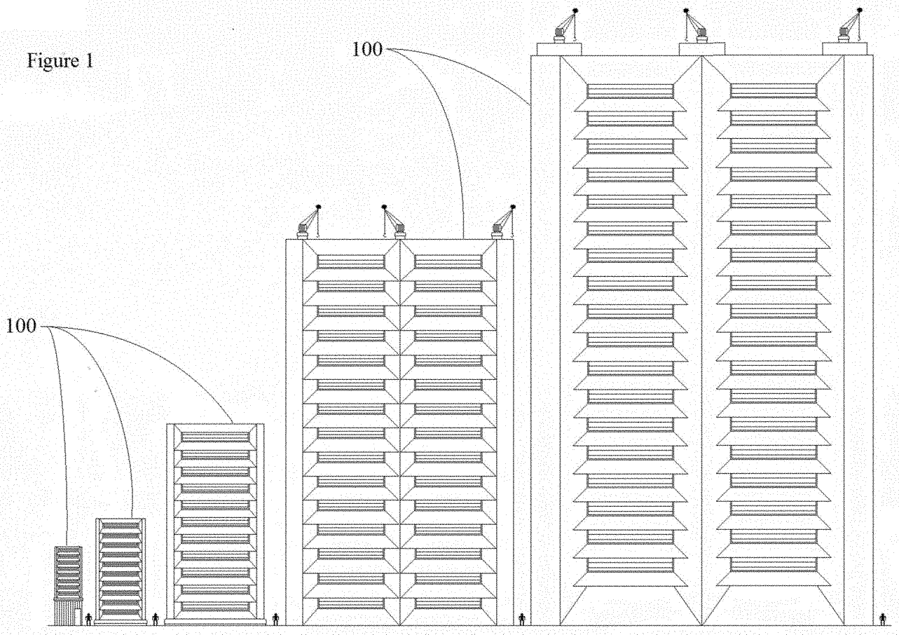

Referring to FIG. 1, the present invention, in its various embodiments, is a wind tower 100. As explained further below, the wind tower 100 of the present invention is made up of at least two generator towers 114 that help define a series of vents 104. These vents 104 direct wind currents to a turbine 106 which is in mechanical communication with electrical generation equipment located in one or both of the generator towers 114. In certain embodiments, wind walls 102 aid in directing wind currents toward the vents 104 thus maximizing the efficiency of the vents 104. As can be observed in FIG. 1, the fundamental elements of the wind tower 100 can be embodied in a variety of configurations all while providing the improved efficiency of its foundational components in harnessing energy from the wind.

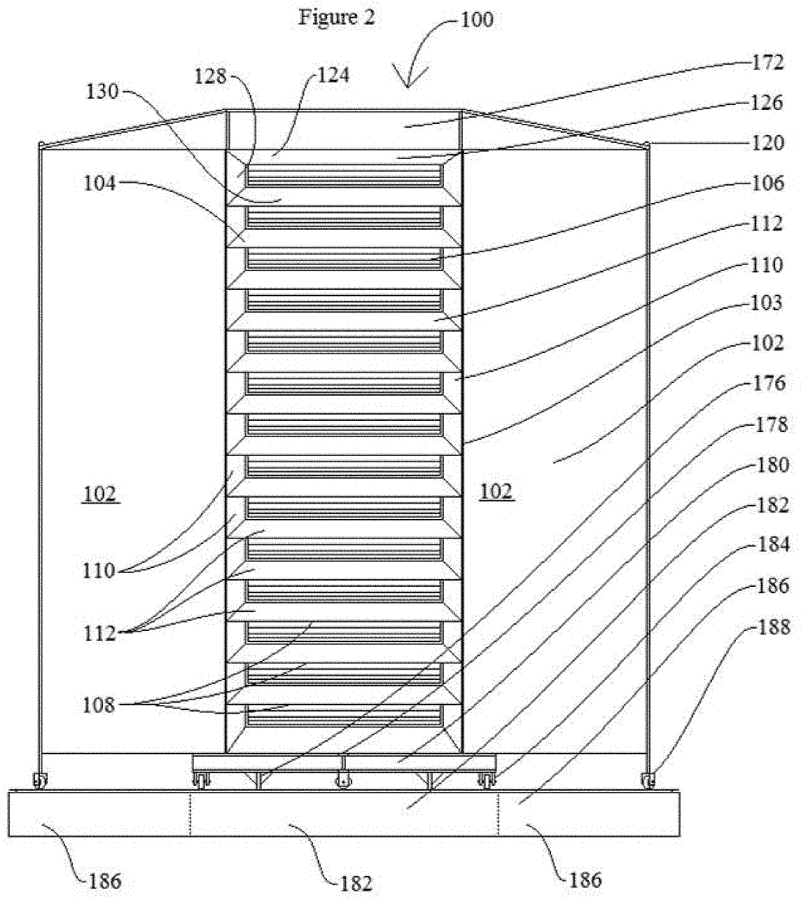

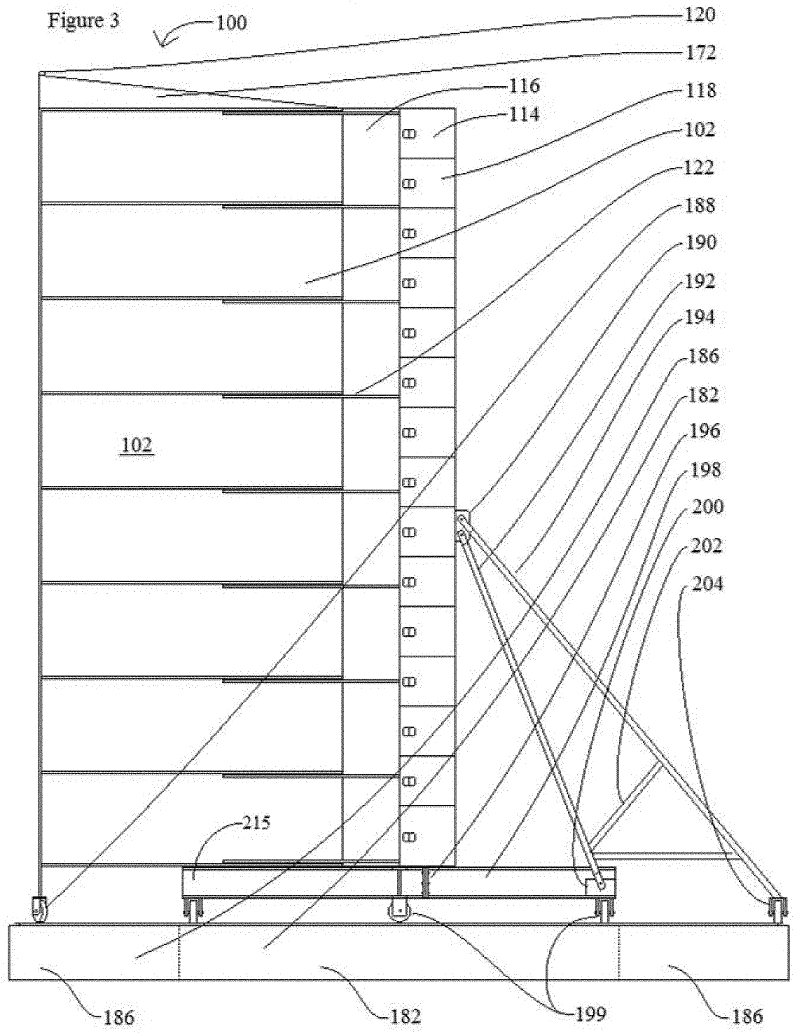

Referring to FIGS. 2 and 3, according to one embodiment of the present invention, the wind tower 100 is a single column of vents 104 flanked by two wind walls 102. The wind walls 102 can be made of a variety of materials including but not limited to steel, aluminum, fiberglass, carbon fiber and plastic alone or in combination. Each vent 104 corresponds to a turbine 106 and serves to direct wind currents toward the turbine 106.

Vents 104 generally include a top wall 108, two sloped sidewalls 110 and a sloped bottom wall 112. These surfaces 108, 110, 112 all serve to capture the wind and direct it more effectively toward the turbines 106. As can be seen in the figures, the top wall 108 of one vent 104 is typically also serving as the bottom wall 112 of the vent 104 above it.

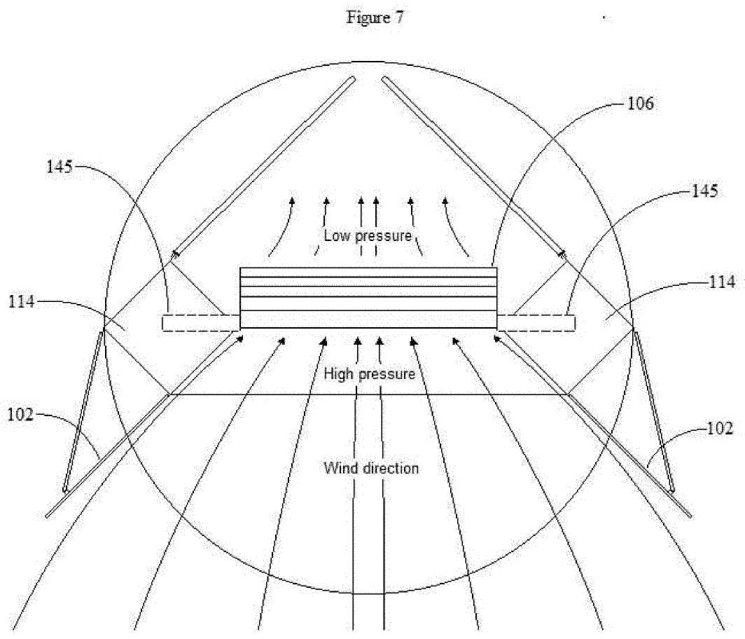

Sidewalls 110 in the vents 104 are typically external walls of the generator towers 114. In other words, as illustrated in FIG. 7, the generator towers 114 provide two functions: 1) they serve as the housing for the electricity generation equipment; and 2) they have a diamond shaped configuration thus allowing their external walls to serve as side walls 110 for the vents 104 to which they are adjacent.

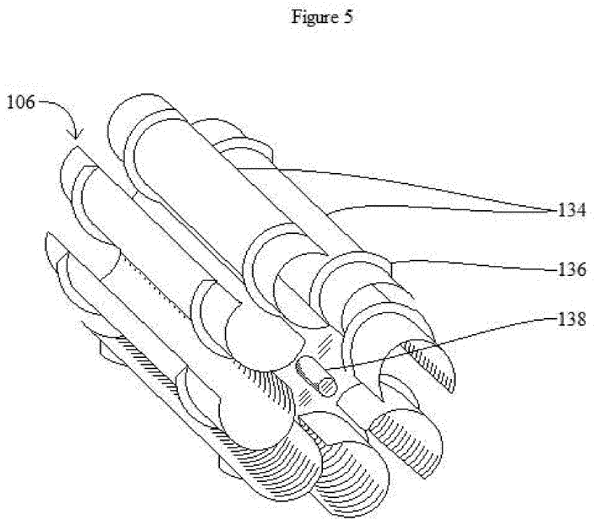

Referring now to FIG. 5, a turbine 106 is depicted according to one embodiment of the present invention. In the illustrated embodiment, the turbine 106 has eight blades 134. However, in other embodiments, the turbines 106 may include more or fewer blades 134 according to need and circumstances. As seen in FIG. 5, the turbine blades 134 are formed in the shape of a tube that has been cut at the top and bottom lengthwise. They can be made of numerous materials including but not limited to aluminum, plastic, fiberglass, or carbon fiber alone or in combination. The turbine blades 134 are mounted to spokes 136. Spokes 136 are shaped to support the turbine blades 134 and can be made of the same materials as the blades 134. In the illustrated embodiment, a center shaft 138 is connected to the spokes 136.

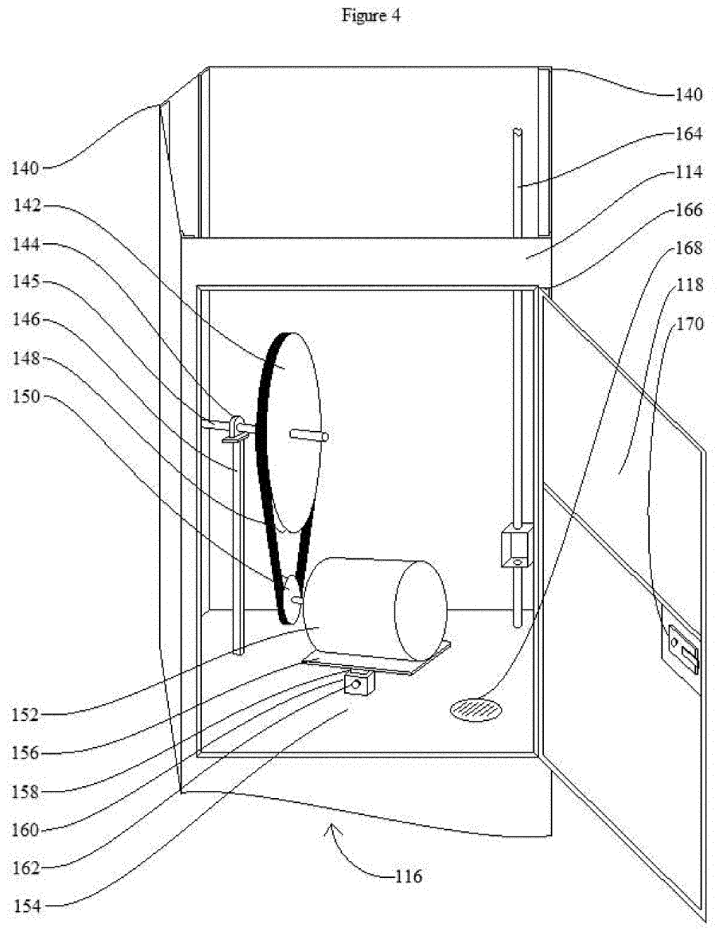

Referring again to FIGS. 2 and 3, each vent 104 and turbine 106 is associated with two generator towers 114 made up of a plurality of generator bays 116. A generator bay 116 according to one embodiment of the present invention is illustrated in FIG. 4. Each generator bay 116 can be accessed by a door 118. As discussed further below, the generator bays 116 are in communication with the turbine 106 and house the components necessary to convert the wind energy into electrical energy. As seen in the illustrated embodiments, bay doors 118 can either line up directly with the vents 104 or could be slightly offset. The generator bay doors 118 provide easy access to the generator bays 116 for maintenance, repairs, and inspections.

The generator bays 116 protect the generators, pulleys, belts, and electrical components from weather damage. The generator bays 116 could incorporate a variety of construction and layout choices as would be apparent to one skilled in the art and that are considered to be within the scope of the present invention. However, in the embodiment illustrated in FIG. 4, structural reinforcements 140 such as a strap iron strip can be secured to the generator bay floors to form forty five degree angles on the inside corners of the generator towers 114 thus supporting the substantially diamond shape exterior as previously discussed. In the illustrated embodiment, a turbine pulley 142 is connected to the center shaft 138 of the turbine 106 and rotates at the same speed as the turbine 106. A carrier bearing 144 can be mounted on a pedestal 146 allowing the center shaft 138 to rotate freely. It is noted that extensions of the center shaft 138 as would be apparent to one skilled in the art could also be utilized. For example, a stub shaft 145 could be slid into the turbine center shaft 138 and connected with a securing mechanism such as a through bolt. In the illustrated embodiment, the carrier-bearing pedestal 146 can be secured to the floor 154 of the generator bay 116 through a variety of known techniques such as welding.

In operation, a drive belt 148 travels over the turbine pulley 142 and a generator pulley 150. Because the generator pulley 150 is smaller in diameter than the turbine pulley 142 the generator 152 rotates faster that the turbine thus creating electricity. In the illustrated embodiment, generator 152 is secured to the generator bay floor 154 with a mounting bracket 156 welded to a mounting sleeve 158. Other mechanisms of securing the generator 152 as would be apparent to one skilled in the art could also be utilized. Utilizing the generator-mounting sleeve 158 allows a user to slide in the generator mounting tube 160 to adjust the drive belt tension. The generator mounting tube 160 can similarly be secured to the generator bay floor 154 through known techniques such as welding. Set bolt 162 can be included to allow for adjustment of the generator 152 height.

In the illustrated embodiment, the generator bay floor 154 supports the generator 152 and carrier-bearing pedestal 146 and forms the diamond shape of the generator tower 114. The structural angle iron 140 can be secured to the generator bay floor 154 and supports the weight of the generator towers 114—which can become substantial depending on the height of wind tower 100 and the number of vent assemblies 104 utilized.

The present invention also allows for electrical communication to take place between stacked generator bays 116. In the illustrated embodiment, conduit and junction boxes 164 house the positive and negative wires that run from the generators 152. As discussed further below, the generator towers 114, divided into multiple generator bays 116, can be mounted on a series of beams serving as a foundation but also allowing rotational movement of the towers 100 in certain circumstances.

Hinge 166 for the bay door 118 can be mounted to the frame of the generator tower 114 and the frame of the bay door 118. Air vents 168 can also be included to allow air to flow through each generator bay 116. Generator bay door 118 can also include a latch 170 allowing it to be closed and locked to protect the generator and other components from unwanted access.

Referring again to FIGS. 2 and 3, one or more high structure warning signals 120 such as a strobe light can be included to alert aircraft to the wind tower 100. Braces 122 can be attached to the generator towers 114 and the wind walls 102 to hold the wind walls 102 in place. Braces 122 can be detached to fold the wind walls in front of the wind turbines. Suitable braces 122 include, but are not limited to square tubing, box tubing, angle iron, or pipe, and can be made of various materials including but not limited to steel, steel alloy, aluminum, carbon fiber, or fiberglass alone or in combination.

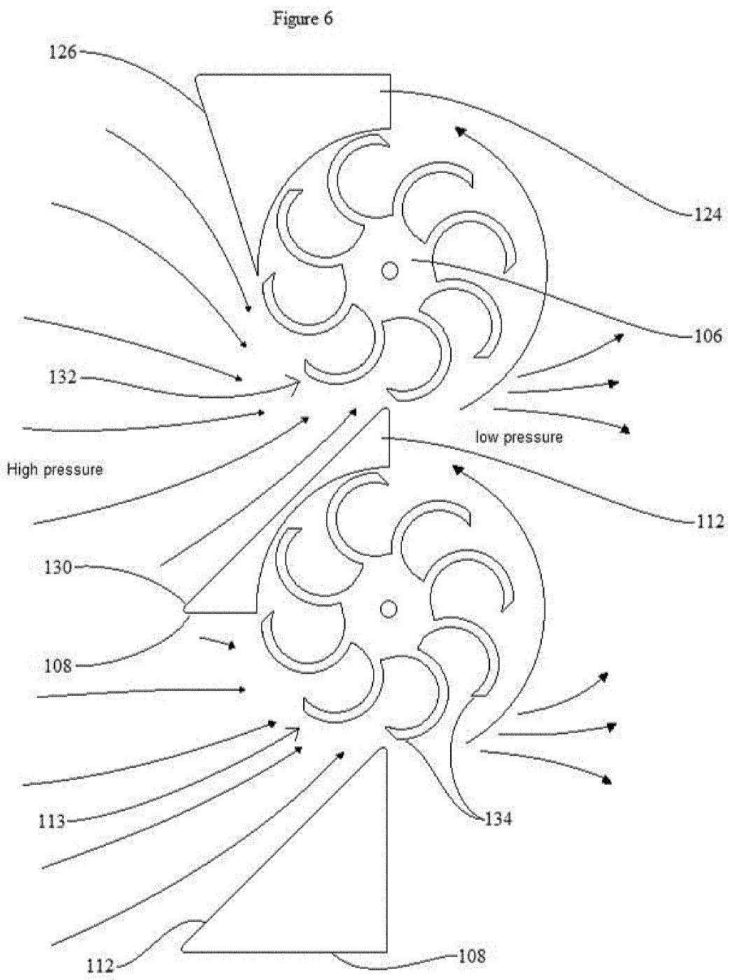

It is noted that, in the illustrated embodiment and in other embodiments discussed herein, each stack of vents 104 can include a cap vent 124 having some unique features. Notably, as seen in FIG. 2, the cap vent 124 includes a top wall 126, two opposite sidewalls 128 and a bottom wall 130. These walls 126, 128, 130 function largely the same as walls 108, 110, 112 discussed above. However, in the cap vent 124, the top wall 126 has an angular orientation that allows it to capture wind that would otherwise merely deflect over the wind tower 100. In particular, as illustrated in FIG. 6, the orientation of the top wall 126 is angled downward, which causes it to deflect the wind contacting it toward the opening 132 to the turbine 106. A flat top wall, in contrast, would direct very little wind toward opening 132 and turbine 106. This embodiment includes an additional wind wall 172 on top of the cap vent 124 which is also secured to the side wind walls 102. The top wind wall 172 prevents wind from escaping over the wind tower 100.

As illustrated in FIGS. 2 and 3, wind walls 102 can include one or more casters 188. These casters 188 allow the weight of the wind walls 102 to be at least partially borne by an outer base track rather than straining at the attachment points. The casters 188 also allow the wind walls 102 to be pivoted to various positions of openness depending on conditions. Other rolling mechanisms as would be apparent to one skilled in the art could also be utilized.

One or more diagonal braces 192, 194 can also be included to provide structural support to the wind tower 100. In the illustrated embodiment, braces 192, 194 can be further connected by one or more supports 202 allowing even greater stability. In the present embodiment, the inner diagonal brace 192 is secured at one end to an upper brace mount 190 and at the other end to a lower brace mount 200. The outer diagonal brace 194 is secured at one end to the upper brace mount 190. The other end is secured to one or more brace casters 204, which are able to roll on an outer base 186. As discussed further below, outer base 186 supports the wind wall casters 188 and the outer diagonal brace casters 204 allowing for rotational movement of both the wind walls 102 and the entire wind tower 100 itself. The inner base 182 supports the weight of the wind tower 100.

Wind tower 100 can also include a beam bracket 196 that can be secured to a back beam 198 with bolts or other known connection mechanisms. When the wind tower 100 is in an upright position the bracket 196 is secured to the back beam 198. However, in certain situations, it would be desirable fold the wind tower 100 down. This feature allows such lowering of the tower 100 by removing the bolts or other mechanisms securing the bracket 196 to the back beam 198. The back beam 198 can also be secured to one or more casters or other suitable rollers 199 that roll on the inner base 182 when the wind tower 100 rotates to face the wind. As used throughout when referring to “beams,” suitable beams for use with the present invention are structural steel I beams. However, other beams suitable for use with the present invention include but are not limited to channel iron, box frame, or square tubing alone or in combination, and can be made of numerous materials including but not limited to steel, or steel alloy alone or in combination.

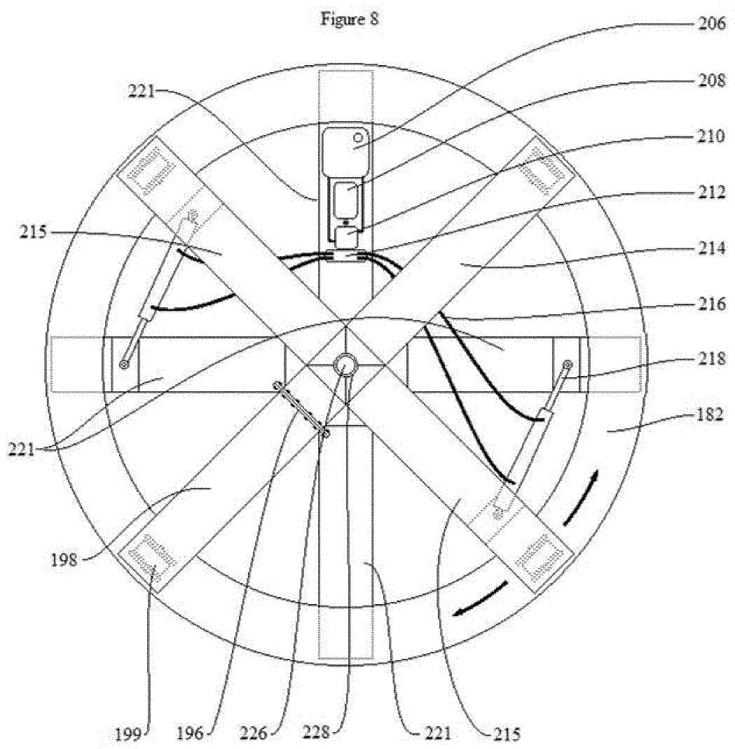

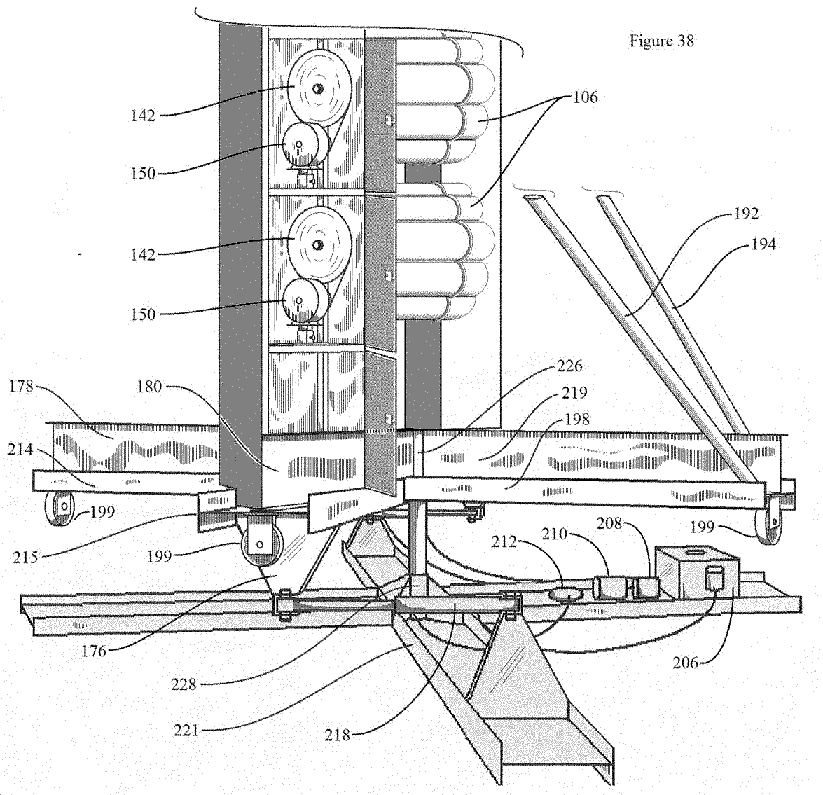

As best seen in FIGS. 8, 10 and 38, wind towers 100 can be mounted on a base structure allowing for partial rotational movement of the towers 100 and their orientation relative to the winds. This is advantageous as it allows the wind towers 100 to be optimally positioned for maximum wind exposure.

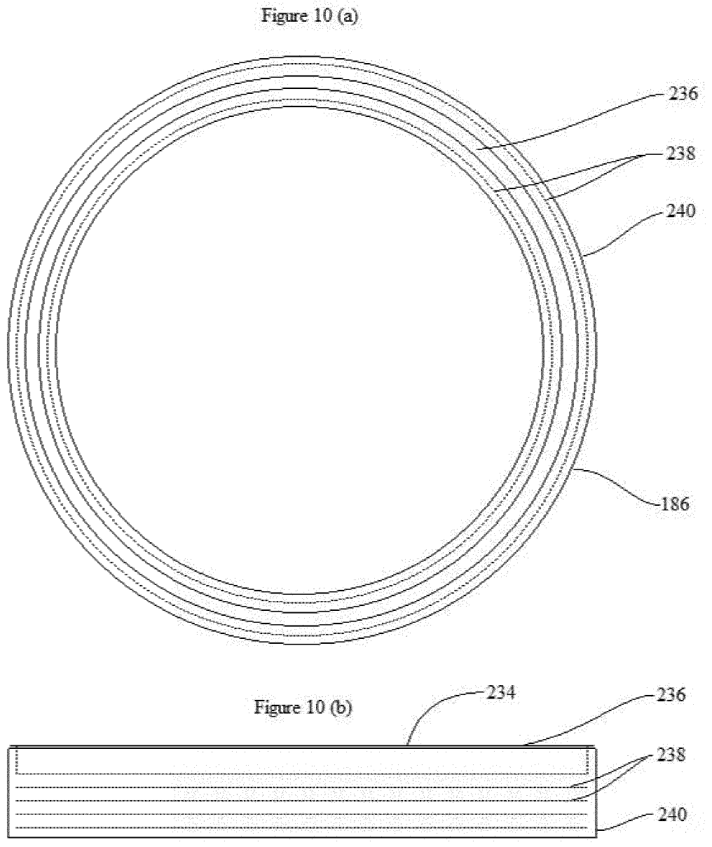

In the illustrated embodiments, the base structure comprises an inner base 182 and an outer base 186 (FIG. 10). Inner base 182 is a heavy cement pad that anchors the wind tower 100, and secures the inner base beams 221. Inner base beams 221 are coupled to side beams 215, a front beam 214 and back beam 198 at a central shaft 228 rotatable around a center pin 226. Hydraulic rams 218 connect the inner base beams 221 to the upper side beams 215.

Side beams 215 rotate on the inner base 182 allowing rotation of the wind towers 100 depending on wind direction. In particular, the generator towers 114 are mounted on the side beams 215. Hydraulic hoses 216 transfer the hydraulic fluid from the shuttle valve 212 to the hydraulic rams 218. The hydraulic rams 218 extend thereby moving the side beams 215 rotationally relative to the center pin 226. Similarly, the removal of hydraulic fluid causes the hydraulic rams 218 to retract thereby moving the side beams 215 rotationally in the opposite direction.

Inner base 182 can be made of cement. This cement can be reinforced with rebar to prevent cracking and crumbling. Inner base 182 could similarly be constructed with other materials including but not limited to cast iron and malleable steel alone or in combination as well as other materials with similar weight and structural properties as would be apparent to one skilled in the art.

As seen in FIG. 8, the inner base beams 221 can be embedded in the inner base 182. One or more caster assemblies 199 can be mounted near the outer ends of the upper beams 215, 214, 198 and travel on the inner base 182. The back beam mounting bracket 196 connects the back beam 198 (FIG. 3) to the other upper beams 214.

The center pin 226 where the upper beams 215, 214, 198 intersect can be reinforced with gussets. The center pin 226 keeps the wind tower 100 centered on the inner base 182. A center shaft 228 can also be secured where the inner base beams 221 intersect. Center shaft 228 can likewise be further secured with one or more gussets. In the illustrated embodiment, the center shaft 228 rotates around the center pin 226.

Hydraulic ram mounts 176 in the illustrated embodiment are secured on the bottom of the side beams 215. Horizontal side beams 215 and vertical side beams 180 support the weight of the generator towers 114. The inner base 182 supports the weight of the wind tower 100. Horizontal front beams 214 and vertical front beams 178 prevent the wind tower 100 and generator towers 114 from tipping forward. Horizontal rear beams 198 and vertical rear beams 219 prevent the wind tower 100 and generator towers 114 from tipping backward. In certain embodiments, the horizontal side beams 215, front beams 214 and rear beams 198 are further supported by casters or other suitable rollers 199 that roll on the base 182 and are located generally beneath the wind towers 100.

Vertical beams 180, 178, 219 are, in the illustrated embodiment, I-beams. However, other beam configurations as would be apparent to one skilled in the art may also be utilized and are considered within the scope of the present invention.

In certain embodiments, upper front beams 214 cross side beams 215 at a substantially central point and are coupled to a central shaft 228 that surrounds a central pin 226. The connection between beams 214, 215 and the central shaft 228 is typically a weld though other connection mechanisms as would be apparent to one skilled in the art could also be utilized. Central shaft 228 is able to at least partially rotate around central pin 226.

A hydraulic reservoir 206 can be utilized to supply hydraulic fluid to a hydraulic pump 210. An electric motor 208 spins the hydraulic pump shaft. The hydraulic pump 210 sends hydraulic fluid under high pressure to a shuttle valve 212. The shuttle valve 212 is controlled by known telemetry sensors and controls (not shown) that read the wind direction and intermediately instruct the shuttle valve 212 to open appropriate chambers extending or retracting the hydraulic rams 218. In this manner, the wind tower 100 is aligned to the telemetry system's weather vane. Reservoir 206, motor 208, pump 210 and shuttle valve 212 are, in the illustrated embodiment, mounted on one of the inner base beams 221. However, other configurations as would be apparent to one skilled in the art are considered within the scope of the present invention.

Referring now to FIG. 10, the outer base 186 can also be a cement foundation 240 with a beam track 236 embedded in the cement 240. As noted previously, the wind wall casters 188 and outer diagonal brace casters 204 roll on the outer base 186 beam track 236 as supported by the cement foundation 240 to offer structural support to the wind walls 102 and the outer diagonal braces 194. Rebar reinforcement 238 can also be included in the outer base 186.

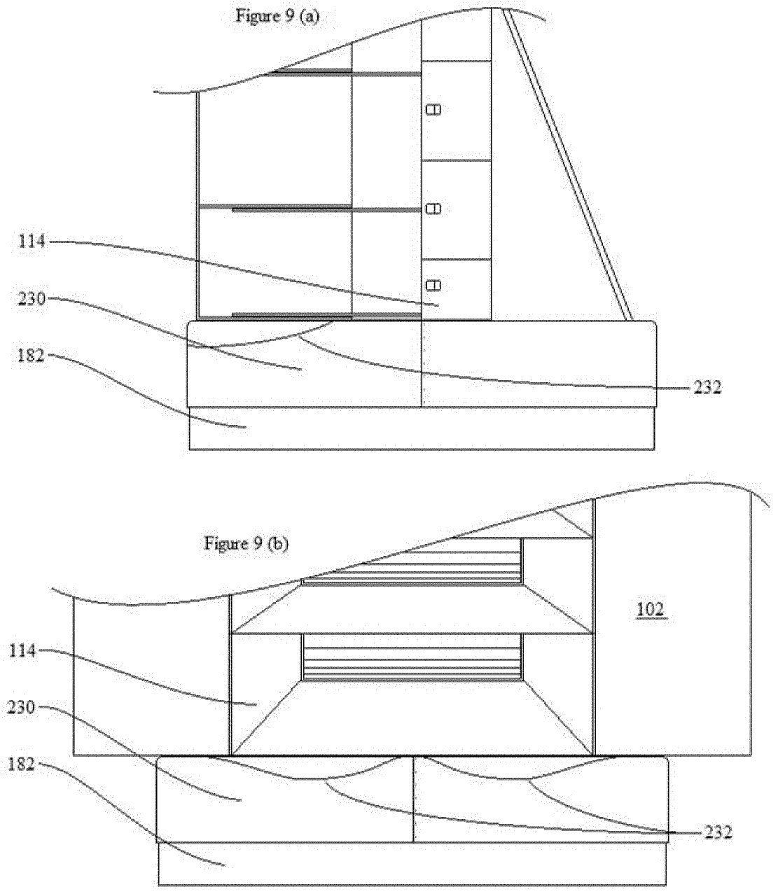

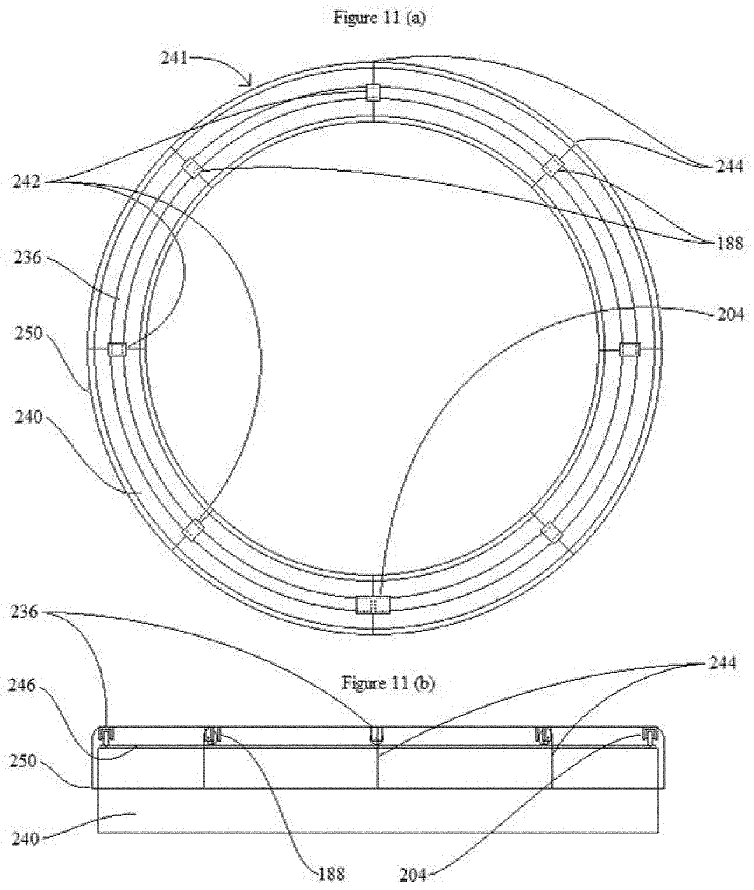

Referring now to FIGS. 9 and 11, inner base 182 and outer base 186 can also be equipped with a turtle deck feature. The inner turtle deck 230 fits over the inner base 182 and the outer turtle deck 250 fits over the outer base 186. The inner turtle deck 230 covers the beam framework and inner base 182 for safety and weather protection. FIGS. 9(a) and (b) depict the generator tower 114 in relation to the inner turtle deck 230. The turtle deck 230 includes one or more dips 232 at their leading edge to direct more wind into the bottom wind turbine. In the illustrated embodiment, the inner turtle deck 230 is divided into four sections that overlap at the edges to seal out the weather, and can be made of numerous materials including but not limited to molded plastic, fiberglass, or carbon fiber alone or in combination.

The outer turtle deck 250 covers the outer base 186 and prevents foreign materials from collecting on the base 186 and rail 236 that could impede the travel of the casters 188, 204. The turtle deck support casters 242 support the turtle deck 250 at the seams to prevent sagging. The seams 244 of the turtle deck 250 overlap one another to form a weather-tight seal. A sectional turtle deck is also advantageous for shipping and storage purposes. As discussed previously, FIG. 11 illustrates how the beam track 236 is embedded in the cement base 240 and provides a smooth surface on which the casters or other suitable rollers 188, 204 can travel. Turtle decks 230, 250 can be made of numerous materials including, but not limited to, aluminum, plastic, fiberglass, or carbon fiber alone or in combination.

To better illustrate the operation of the presently illustrated embodiment, the following description is given regarding its method of operation. However, the method should be regarded as exemplary only and not intended to limit the operation of the present invention in its various embodiments.

In operation, the presently illustrated embodiment would be placed in a high-wind area. The wind walls 102 collect a large amount of wind and funnel it into the turbines 106. As depicted in FIG. 6, the vents 104 block the wind from the upper half of the turbines 106 and guide airflow into the lower half of the turbines 106 at an optimal angle. The top wind wall 172 (FIG. 2) is mounted to the top wall 126 of the cap vent 124. The top and side wind walls 172, 102 prevent wind from escaping over and around the wind tower 100. The cap vent top wall 126 also guides wind into the top turbine 106 and prevents wind from escaping over the wind tower 100. The upward facing walls 112 of vents 104 guide airflow into the turbines 106. Sidewalls 110 formed by generator towers 114 also guide the airflow into the turbines 106. Rubber seams 103 cover the gaps between the wind walls 102 and the generator towers 114 to prevent air from escaping. Wind walls 102 act as a funnel to provide higher wind speeds through the turbines 106. The wind turbines 106 have a close tolerance to the generator towers 114 and vents 104 for greater efficiency.

As depicted in FIG. 7, the selective direction of the wind allows a pressure gradient to develop on the front and back sides of the turbine 106. In particular, the air pressure on the front of the turbine 106 (i.e. the portion of the turbine 106 facing the wind) is higher than the air pressure on the back of the turbine 106. This pressure differential results in additional airflow through the turbines 106 that exceeds the speed of the actual wind. In particular, the cap vent 124—with or without the top wind wall 172—prevents air from escaping over the wind tower 100. The turbines 106 are pushed by high air pressure and pulled by low air pressure making them more efficient. The middle vents 104 force wind into the lower half of the turbines 106. The bottom vent 104 directs the wind from the turtle deck 230 into the bottom turbine 106.

Wind funneling, as depicted in FIG. 7, is the effect created by forcing a large surface area of wind through a small opening. The wind speed increases as it passes through the turbines 106 thus creating more electricity.

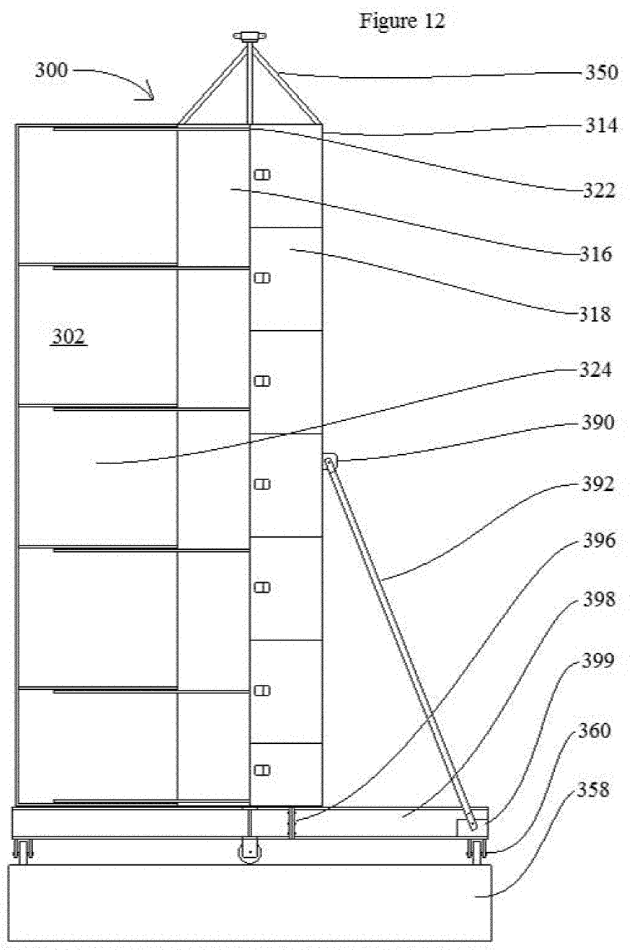

Referring now to FIGS. 12-15 and 44, wind tower 300 is shown according to yet another embodiment of the present invention. This wind tower 300 is similar in many respects to the wind tower 100 discussed in connection with FIGS. 2 and 3. One notable difference is the absence of a top wind wall 172. Wind tower 300 is again a single column of vents 304 flanked by two wind walls 302. Again, wind walls 302 can be made of a variety of materials including, but not limited to those mentioned previously in connection with other embodiments alone or in combination. Each vent 304 corresponds to a turbine 306 and serves to direct wind currents toward the turbine 306.

Vents 304 generally include a top wall 308, two sloped sidewalls 310 and a sloped bottom wall 312. These surfaces 308, 310, 312 all serve to capture the wind and direct it more effectively toward the turbines 306. Again, as can be seen in the figures, the top wall 308 of one vent 304 is typically also serving as the bottom wall 312 of the vent 304 above it. However, as noted previously, in this and all embodiments discussed herein, some spatial separation may exist between the top and bottom walls and is considered within the scope of the present invention.

Sidewalls 310 in the vents 304 are again typically external walls of the generator towers 314. In certain embodiments, there may be some spatial separation between the external wall of the generator tower 314 and sidewalls 310.

Each vent 304 and turbine 306 is associated with two generator towers 314—one on each side—made up of a plurality of generator bays 316. Each generator bay 316 can be accessed by a door 318. The generator bays 316 are in communication with the turbine 306 and house the components necessary to convert the wind energy into electrical energy.

Braces 322 can be attached to the generator towers 314 and the wind walls 302 to hold the wind walls 302 in place. Braces 322 can be detached to fold the wind walls in front of the wind turbines. Suitable braces 322 include, but are not limited to those discussed previously herein in connection with other embodiments.

Each stack of vents 304 can include a cap vent 324 having a top wall 326, two sidewalls 328 and a bottom wall 330. Again, these walls 326, 328, 330 function largely the same as walls 308, 310, 312 discussed above. However, in the cap vent 324, the top wall 326 has an angular orientation that allows it to capture wind that would otherwise merely deflect over the wind tower. In particular, the orientation of the top wall 326 is angled downward, which causes it to deflect the wind contacting it toward the turbine 306. Whereas only a small portion of wind contacting a flat top wall would otherwise be directed to the turbine 306. The orientation of the vents 304 in the tower 300 allows the wind wall to collect a large amount of wind and funnel it into the turbines 306 while the vents 304 block the wind from the upper half of the turbines 306 and guide airflow into the lower half of the turbines 306 at the optimal angle. As discussed previously herein in connection with other embodiments, the wind turbines 306 have a close tolerance to the generator towers 300 and vents 304 for greater efficiency. The upward facing vents guide airflow into the turbines 306 as do the side walls 310 formed by the generator towers 314. Rubber seam covers 303 cover the gaps between the wind walls 302 and the generator towers 314 to prevent air from escaping. Because they are flexible, they allow the wind walls to be folded without having to detach them.

The tower 300 can include one or more upper diagonal brace mounts 390. These can be welded or otherwise secured to the generator tower 314. Diagonal braces 392 can also be included. Such braces 392 in the illustrated embodiment are bolted or otherwise secured to the diagonal brace mounts 390, 399 to make the wind tower 300 more ridged. A back beam bracket 396 can be secured to a back beam 398 when the wind tower 300 is standing but can be removed along with the diagonal braces 392 to lay the structure down. As discussed previously in connection with other embodiments, back beam 398 can be bolted or otherwise secured to one or more casters 360 that roll on the base 358 when the wind tower rotates to face the wind as depicted in FIG. 12.

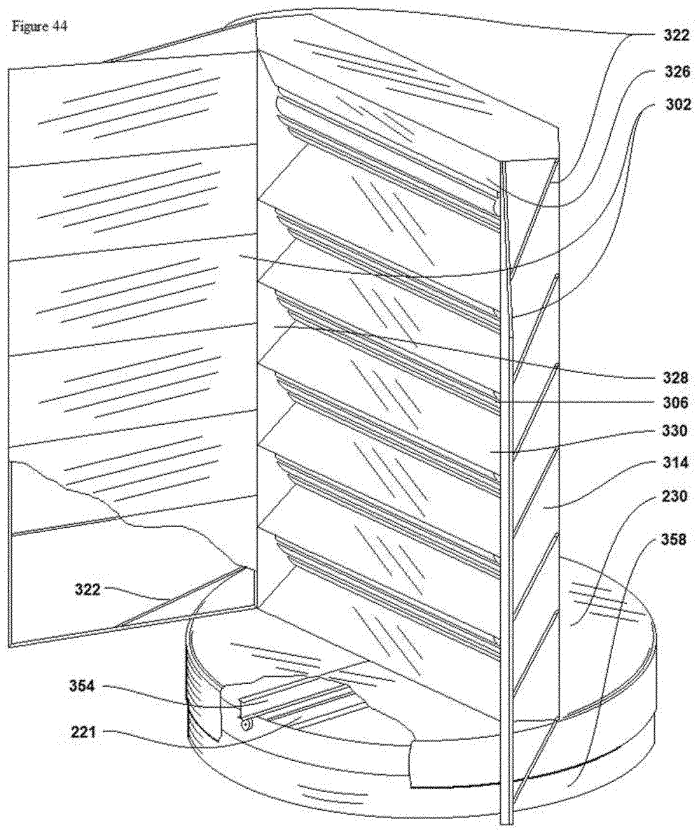

As seen in FIG. 44, base 358 can also be equipped with a turtle deck 230—which in this illustration is shown in broken view with inner base beams 221 and front beams 354 visible. FIG. 44 also provides a broken view of a wind wall 302 according to one embodiment of the present invention with the braces 322 attaching the wind wall 302 to the generator tower 314 visible.

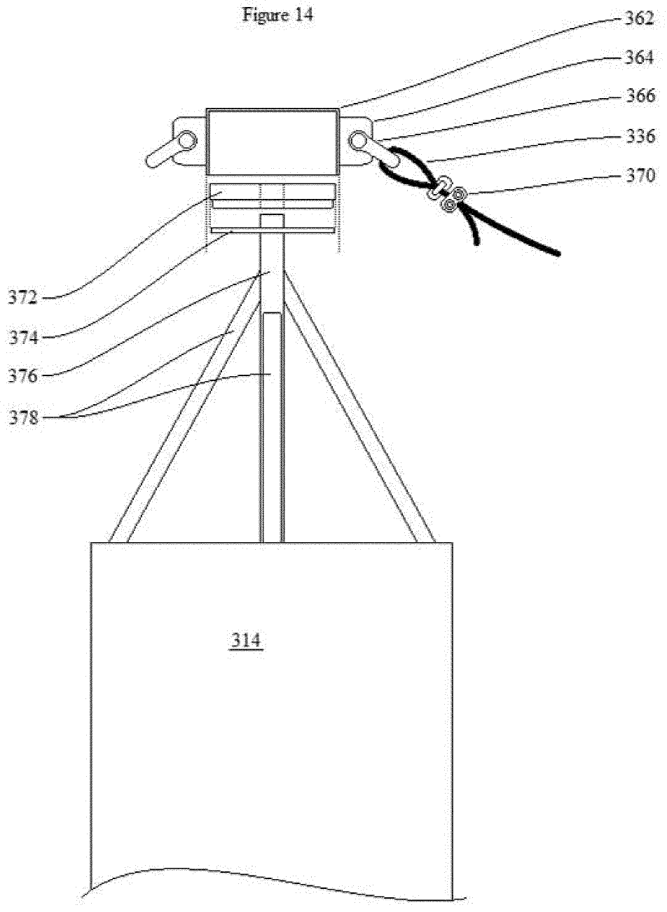

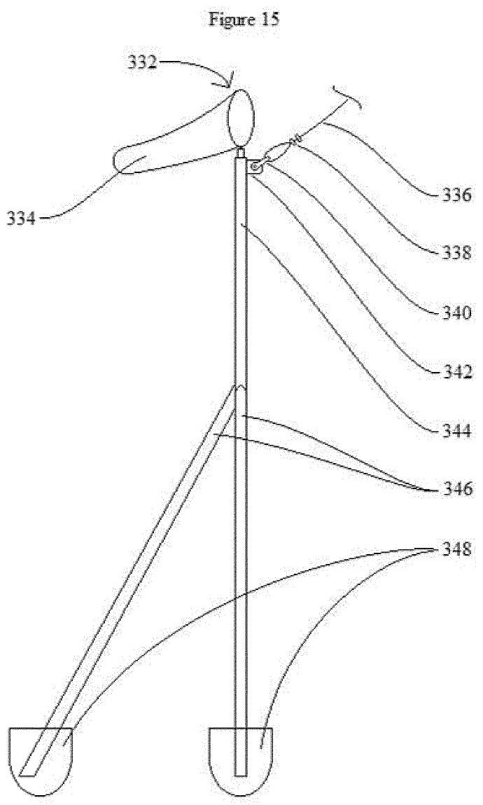

Referring now to FIGS. 14 and 15, guidelines 336 and anchors 332 can be utilized with the present invention to provide additional structural security. This is especially important for large structure. In one embodiment, anchors 332 are located approximately ninety feet out from the center of the wind tower 300 at sixty, one hundred, and three hundred degrees relative to the front center of the wind tower 300. However, other anchoring configurations could be utilized depending on need and circumstances. The anchors 332 are secured in the ground. This can be accomplished with cement or other known security mechanisms. The anchors 332 are then attached to a guideline 336 with a guideline mount 350. Each anchor 332 can include a windsock 334 mounted to it that can be used as a visual reference that the wind tower 300 is facing the optimal direction. One or more cable clamps 338 can be employed to prevent the loop in the cable from slipping. A clevis 340 can be used to connect the eyelets 342 to the guideline 336. Eyelet 342 can be secured to a center pole 344 and attached to the clevis 340. The center pole 344 can then be cemented or otherwise secured in the ground. One or more diagonal braces 346 can give the anchor 332 additional strength and rigidity. Where cement is used, the cement base 348 can be a single cement pad poured below ground level or individual pours for the center pole 344 and each diagonal brace 346, also below ground level.

The guideline mount 350 can be secured on the top of the wind tower 300 structure. Its purpose is to prevent the structure from collapsing in high winds. In the presently illustrated embodiment, cap 362 is in a stationary position on top of a load bearing 372. Eyelets 364 can be welded or otherwise secured to the cap 362 and are attached to the clevis 366. The clevis's 366 connect the eyelets 364 to the guidelines 336. The guidelines 336 connect to the anchors 332 as discussed above. Cable clamps 370 can be included to prevent the loop in the cable from slipping. Load bearing 372 allows the cap 362 to remain stationary while the wind tower 300 is rotating. Bearing support plate 374 can be secured to a pedestal 376 to support the load bearing 372. Pedestal 376 can be secured to the wind tower 300 structure and supports the load bearing 372 and cap 362. Diagonal braces 378 can also be included to provide support for the pedestal 376.

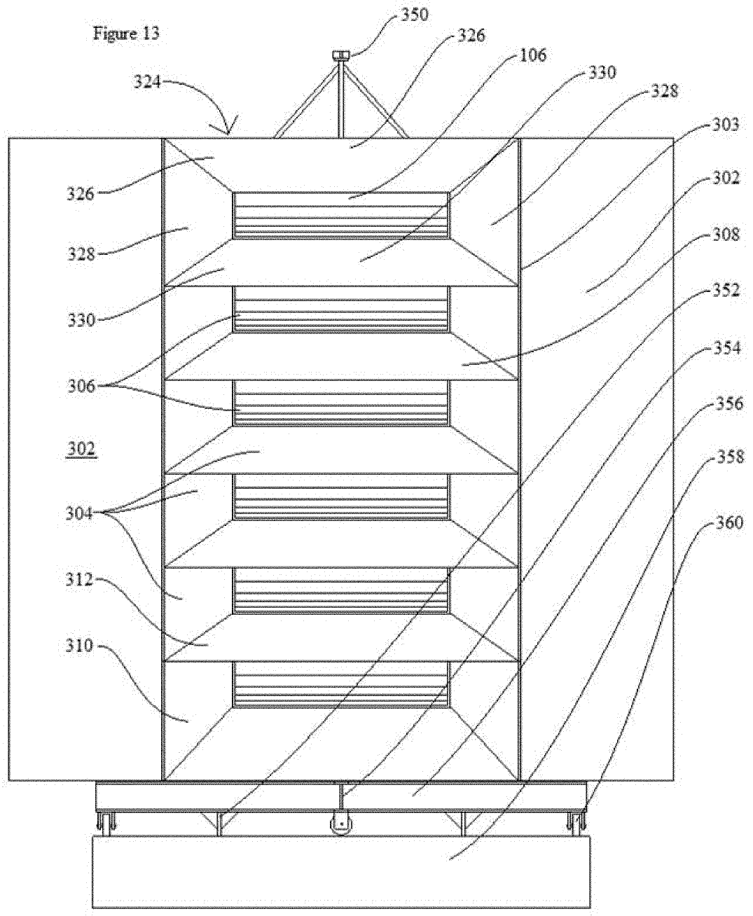

The base for the presently described tower is like the base described in connection with FIG. 8 in most material respects. It is typically a heavy cement pad that anchors the wind tower 300 and secures the base beams (not shown). As can be seen in FIG. 13, the interface between the wind tower 300 and base 358 can include front and side beams 354, 356 that, among other things, prevents the wind tower from tipping forward and supports the weight of the generator towers respectively. Hydraulic ram mounting brackets 352 for rotation of the tower 300 as discussed previously in connection with other embodiments are also shown.

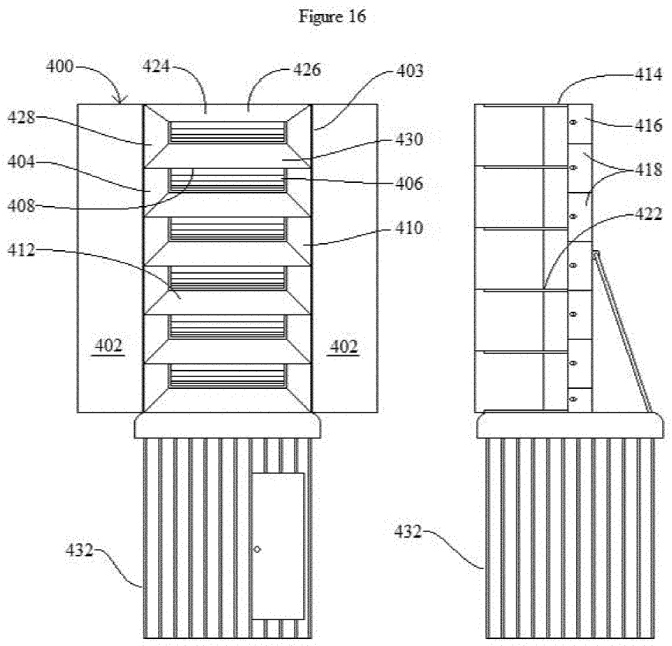

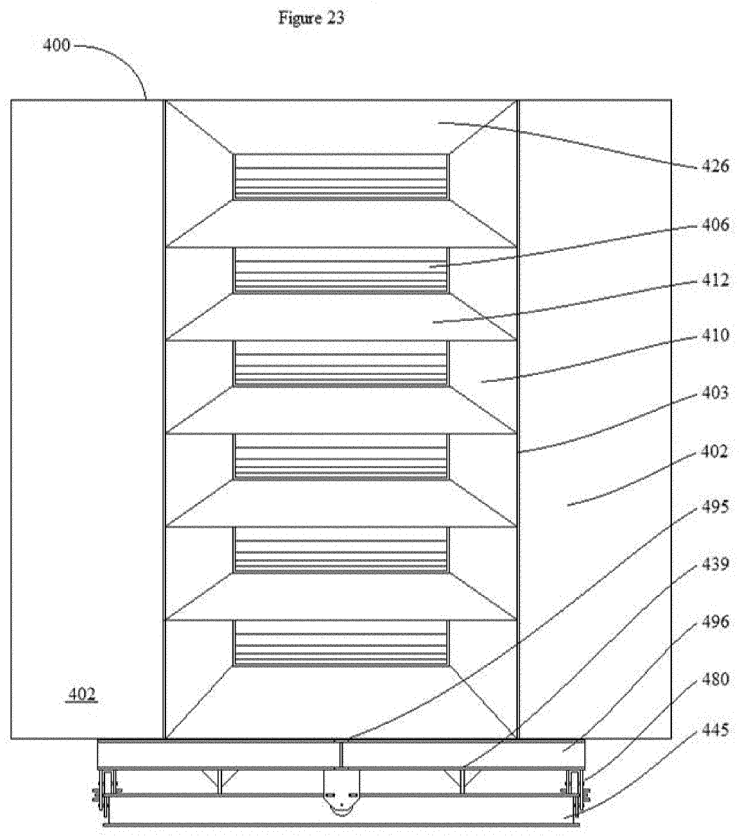

Referring now to FIGS. 16, 22 and 23, wind tower 400 is shown according to yet another embodiment of the present invention. This wind tower 400 is similar in many respects to the wind towers 100, 300 discussed previously. One notable difference is that the present wind tower 400 sits on top of an electronics shack 432. Electronics shack 432 houses the battery bank, power inverter, and other electronics required to harness the energy created by the wind tower.

Wind tower 400 is again a single column of vents 404 flanked by two wind walls 402. Again, wind walls 402 can be made of a variety of materials alone or in combination. Each vent 404 corresponds to a turbine 406 and serves to direct wind currents toward the turbine 406.

Vents 404 include a top wall 408, two sloped sidewalls 410 and a sloped bottom wall 412. These surfaces 408, 410, 412 all serve to capture the wind and direct it more effectively toward the turbines 406. Sidewalls 410 in the vents 404 are again typically external walls of the generator towers 414.

Each vent 404 and turbine 406 is associated with two generator towers 414—one on each side—made up of a plurality of generator bays 416. Each generator bay 416 can be accessed by a door 418. The generator bays 416 are in communication with the turbine 406 and house the components necessary to convert the wind energy into electrical energy.

Braces 422 can be attached to the generator towers 414 and the wind walls 402 to hold the wind walls 402 in place. Braces 422 can be detached to fold the wind walls in front of the wind turbines. Suitable braces 422 can be made of numerous materials alone or in combination as discussed in connection with other embodiments discussed herein.

Each stack of vents 404 can include a cap vent 424 having a top wall 426, two sidewalls 428 and a bottom wall 430. Again, these walls 426, 428, 430 function largely the same as walls 408, 410, 412 discussed above. However, in the cap vent 424, the top wall 426 has an angular orientation that allows it to capture wind that would otherwise merely deflect over the wind tower. Again, the orientation of the vents 404 in the tower 400 allows the wind wall to collect a large amount of wind and funnel it into the turbines 406 while the vents 404 block the wind from the upper half of the turbines 406 and guide airflow into the lower half of the turbines 406 at the optimal angle. Rubber seam covers 403 cover the gaps between the wind walls 402 and the generator towers 414 to prevent air from escaping. Because they are flexible, they allow the wind walls to be folded without having to detach them. Front beam 495 prevents the wind tower 400 from tipping forward. Side beam 496 again support the weight of the generator towers 414.

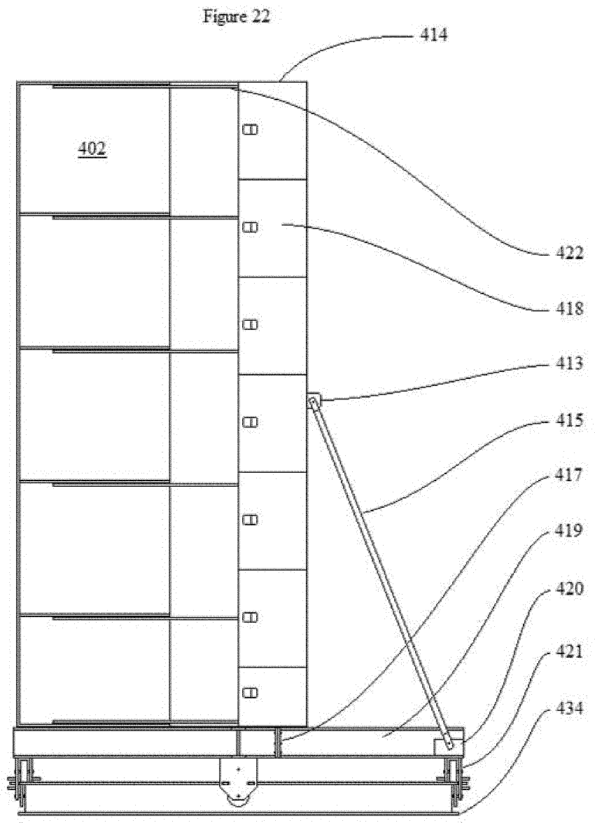

Referring more particularly to FIG. 22, wind tower 400 can include one or more diagonal braces 415 secured to one or more brace mounts 413, 420. The back beam bracket 417 is bolted or otherwise secured to the back beam 419 when the wind tower is standing, but can be removed along with the diagonal braces 415 to lay the structure down. The back beam 419 is bolted or otherwise secured to a caster assembly or other rolling mechanism 421 that allows the wind tower 400 to rotate to face the wind. It is noted that the term casters is used in connection with multiple embodiments discussed herein. However, the present invention is not intended to be limited to only casters. Other known rolling mechanisms as would be apparent to one skilled in the art are considered to fall within the meaning of that term and are considered within the scope of the present invention.

The lower diagonal brace mounts 420 are welded or otherwise secured to the back beam 419, and are bolted or otherwise secured to the diagonal braces 415. As discussed more below, casters 421 are mounted on the upper beams and travel on the wind tower track 434, which is welded or otherwise secured to roof beams 436 located on the electronics shack 432.

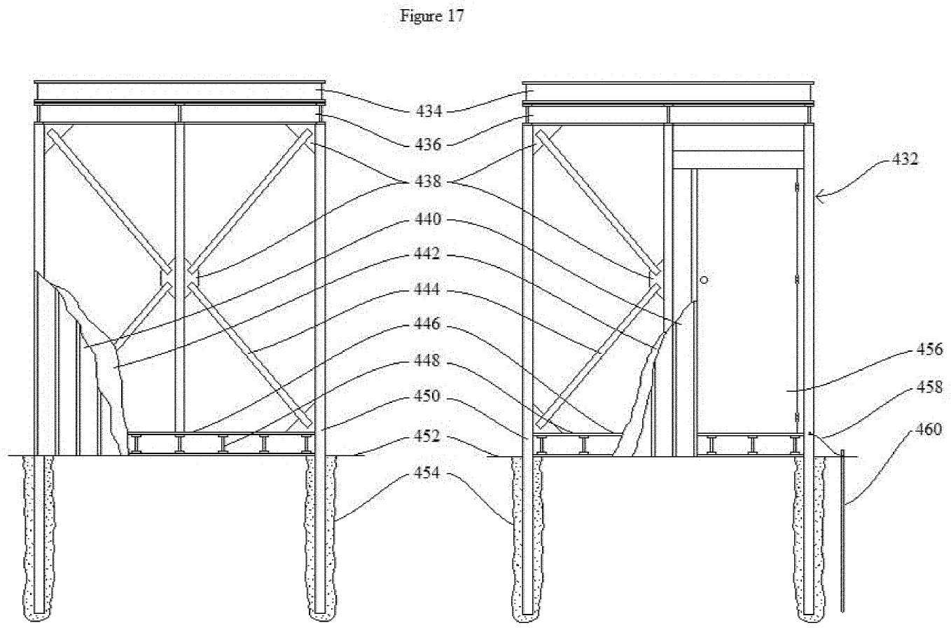

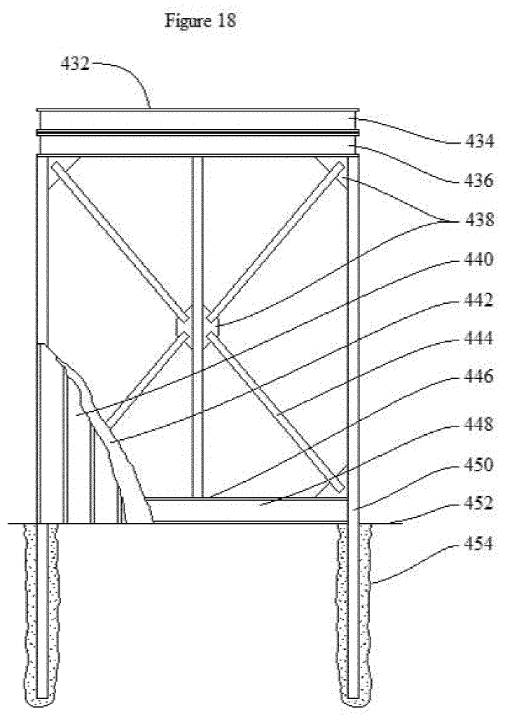

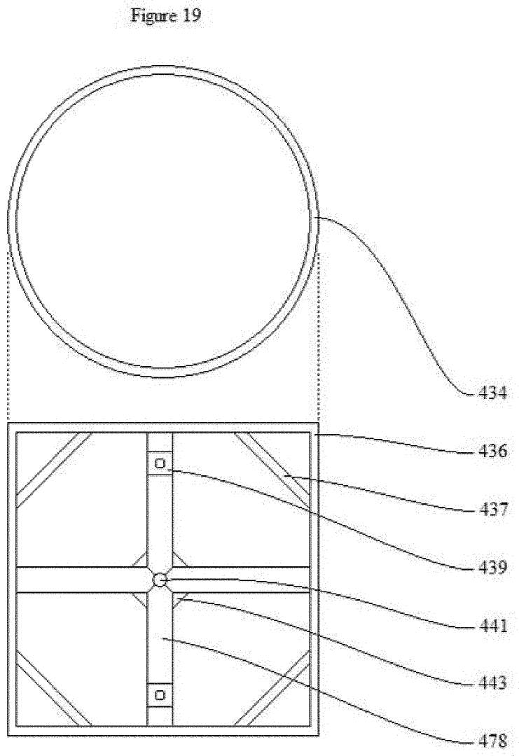

Referring now to FIGS. 17-21 the connection of the wind tower 400 with the electronics shack 432 is discussed further. In one embodiment of the present invention, beam tower track 434 is bowed into a circle in a circumference to align with the casters 421 on the wind tower side beams 473, front beams 472 and back beams 483 as discussed further below. Beam tower track 434 is then welded or otherwise secured to one or more roof beams 436 and roof diagonal braces 437. Roof beams 436 are in turn welded or otherwise secured to one or more structural supports 450 in the electronics shack 432. Hydraulic ram mounts 439 can be used to secure one or more hydraulic rams 476 to the beam base 478.

In the illustrated embodiment, center shaft 441 receives the center pin 484 from the wind tower 400 thereby centering the wind tower 400 so the casters or other suitable rollers 421 stay on the beam wind tower track 434. Beam base gussets 443 can be utilized to strengthen the connection between the base beams 478. Beam base 478 supports the center shaft 441 and the hydraulic ram mounts 439.

In one embodiment of the electronics shack 432, one or more gussets 438 can be utilized to provide strength and rigidity to the diagonal braces 444 and structural supports 450. In the illustrated embodiment, metal siding 440 can be screwed or otherwise secured to the diagonal braces 444, supports 450, and doorframe to protect against the weather. Insulation board 442 can also be sandwiched between the metal siding 440 and electronics shack framework to help moderate the building's interior temperature. Diagonal braces 437, 444 help to maintain the structural integrity of the electronics shack 432. Floor decking 446 can be a thin layer of deck plate that is attached to the floor joists 448 that are in turn welded or otherwise secured to the structural supports 450. Structural supports 450 can be cemented or otherwise secured into the ground. Element 452 illustrates the ground levels proximity to the electronics shack 432 according to one embodiment. Cement foundation 454 can secure the structural supports 450 and prevent the electronics shack 432 and wind tower 400 from tipping over. Door 456 provides access to the electronics shack 432 when open and a weather barrier and theft protection when closed and locked. Ground cable and clamps 458 can be used to connect the electronics shack 432 to the grounding rod 460, which discharges electrical currents from the electronics shack 432, and wind tower 400 into the ground.

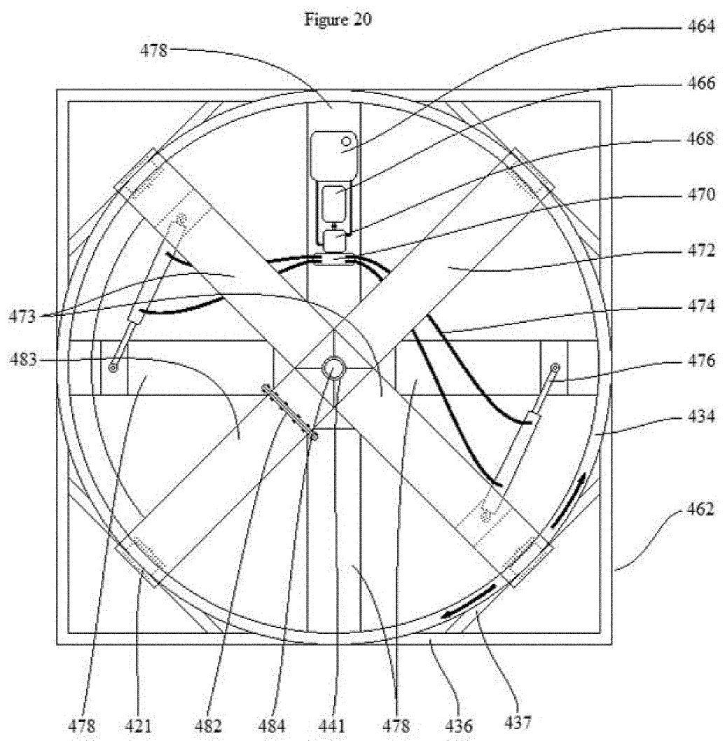

Referring now to FIG. 20, a base 462 suitable for use in connection with wind tower 400 is disclosed. Base 462 in the illustrated embodiment includes one or more hydraulic reservoirs 464 that supply hydraulic fluid to one or more hydraulic pumps 468. Electric motor 466 can be used to spin the hydraulic pump shaft, which then causes the hydraulic pump 468 to send hydraulic fluid under high pressure to a shuttle valve 470. Shuttle valve 470 is controlled by known telemetry sensors and controls (not shown) that read the wind direction and intermediately instruct the shuttle valve 470 to open to extend or retract hydraulic rams 476 that thereby align the wind tower 400 and the telemetry's weather vane. In the illustrated embodiment, hydraulic reservoir 464, hydraulic pump 468, electric motor 466 and shuttle valve 470 are mounted on one of the base beams 478. Upper beams 473, 472, 483 rotate on the beam tower track 434. In the illustrated embodiment, generator towers 414 are mounted on the side beams 473. Hydraulic hoses 474 transfer the hydraulic fluid from the shuttle valve 470 to the hydraulic rams 476. As hydraulic rams 476 extend, they rotate the wind tower 400 counterclockwise and, as they retract, they rotate the wind tower 400 clockwise.

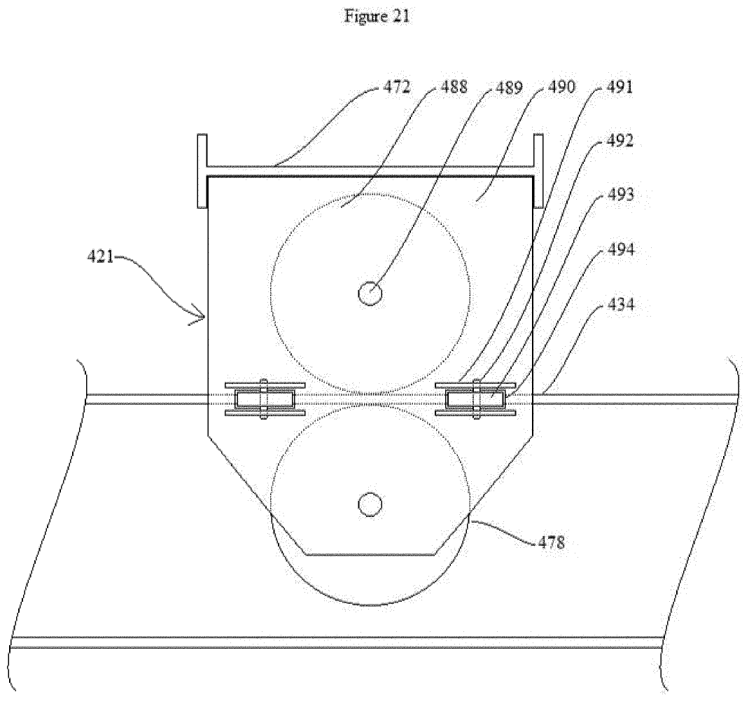

In the illustrated embodiment, the beam wind tower track 434 guides the caster assemblies 421. Base beams 478 are welded or otherwise secured to the roof beam 436. As discussed further in FIG. 21, casters 421 are mounted near the outer ends of the upper front beam 472, upper back beam 483 and both upper side beams 473 and travel on the beam wind tower track 434. Back beam mounting bracket 482 connects the upper back beam 483 to the upper front beam 472. A center pin 484 can be welded or otherwise secured in the center where the upper front beams 472 and side beams 473 intersect and can be reinforced with welded gussets. Center shaft 441 can be welded where the base beams 478 intersect and is reinforced with welded gussets. The center pin 484 rotates in the center shaft 441.

Referring now to FIG. 21, a caster assembly 421 and its interaction with upper beam 472 is shown according to one embodiment of the present invention. Caster assembly 421 can include one or more caster wheels 488. The caster wheels 488 roll on the top of the beam wind tower track 434 while the lower caster wheels 487 roll under the top plate of the beam wind tower track 434, to prevent the caster assembly 421 from pulling away from the track 434. Caster pins 489 can be used to hold the caster wheels 487, 488 in place. Gussets 490 can also be included to hold the caster assembly 421 in place. In the illustrated embodiment, the guide roller mounting brackets 491 are welded or otherwise secured to the gussets 490. Guide roller pins 492 can be fastened to the guide roller mounting brackets 491. Guide rollers 493 roll on the guide roller pins 492 and travel against the top plate of the beam wind tower track 434 to help keep the wind tower 400 centered on the electronics shack 432. Guide roller slots 494 are cut through the gussets 490 in the presently illustrated embodiment to allow the guide rollers 493 to roll on the top plate of the wind tower track 434.

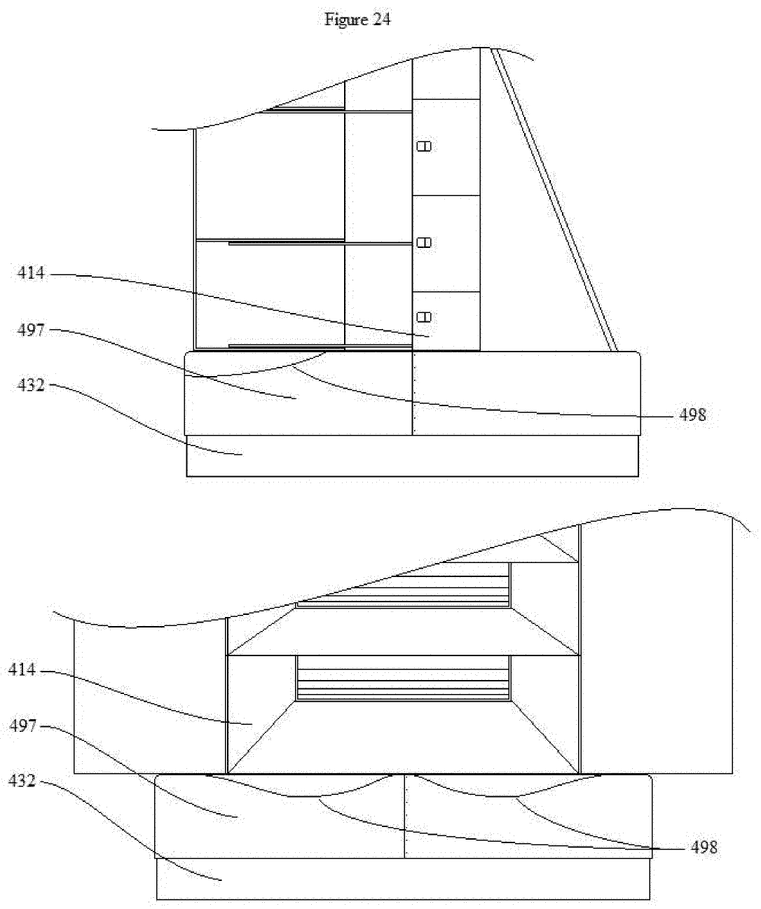

Referring to FIG. 24, the wind tower 400 can also be fitted with a turtle deck 497 that covers the beam framework and electronics shack base 432 for safety and weather protection. Similar to other turtle decks discussed herein, turtle deck 497 includes one or more dips 498 on the leading edge directing wind to the bottom vents 404. Turtle deck 497 in the illustrated embodiment is divided into four sections that overlap at the edges to seal out the weather. Turtle deck 497 can be made of numerous materials alone or in combination including but not limited to molded plastic, fiberglass and carbon fiber.

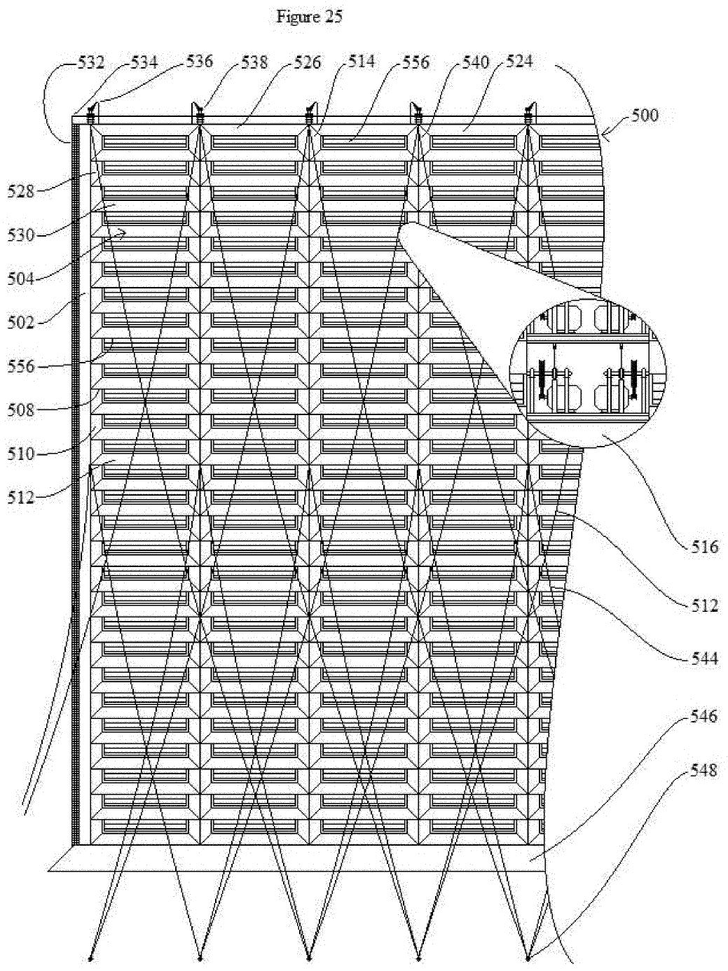

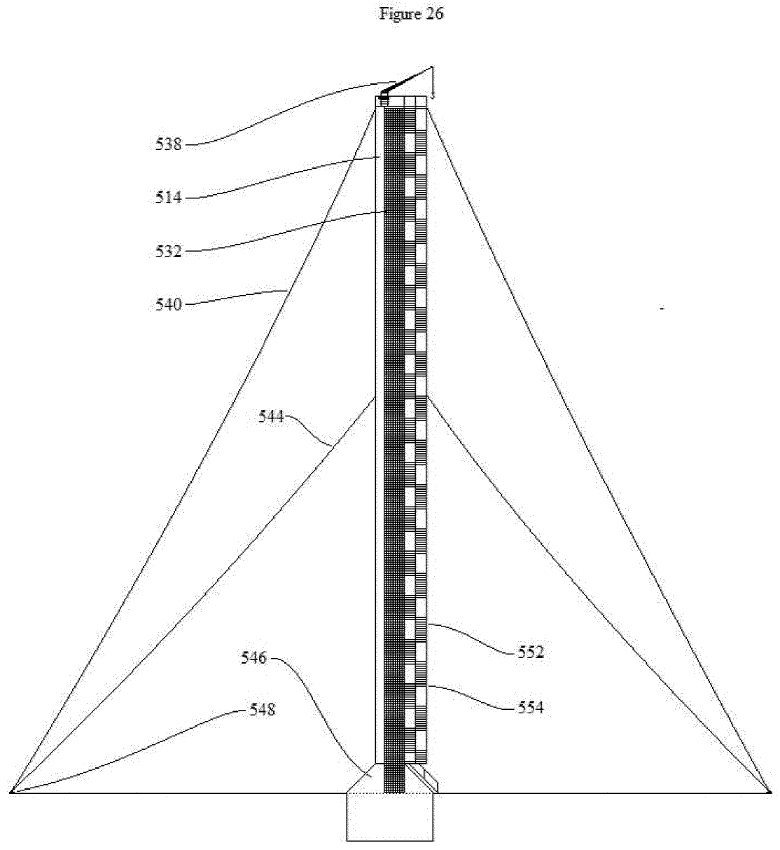

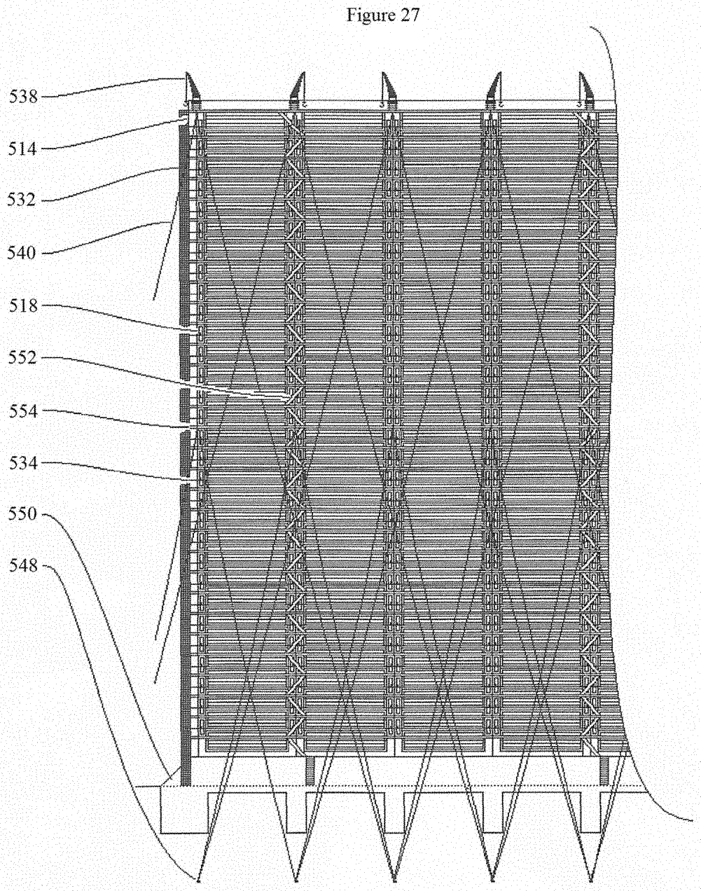

Referring to FIGS. 25-27, a wind tower 500 is shown according to yet another embodiment of the present invention. The wind tower 500 in this embodiment is multiple columns of vents 504. Each vent 504 corresponds to a turbine 556 and serves to direct wind currents toward the turbine 556. In certain embodiments, the turbines 556, illustrated in FIG. 5, will have eight blades. In other embodiments, the turbines 556 will have fewer or more blades. In one embodiment, the turbines 556 have up to twelve blades.

Vents 504 include a top wall 508, two sloped sidewalls 510 and a sloped bottom wall 512. These surfaces 508, 510, 512 all serve to capture the wind and direct it more effectively toward the turbines 556. Sidewalls 510 in the vents 504 are again typically external walls of the generator towers 514.

Each vent 504 and turbine 556 is associated with two generator towers 514 made up of a plurality of generator bays 516. The generator tower's 514 diamond shape funnels the wind into the turbines 556 and reduces the wind resistance of the tower. Each generator bay 516 can be accessed by a door 518. In certain embodiments, each generator bay 516 has two doors 518 (one for each generator). The generator bays 516 are in communication with the turbine 556 and house the components necessary to convert the wind energy into electrical energy.

Each stack of vents 504 can include a cap vent 524 having a top wall 526, two sidewalls 528 and a bottom wall 530. Again, these walls 526, 528, 530 function largely the same as walls 508, 510, 512 discussed above. However, in the cap vent 524, the top wall 526 has an angular orientation that allows it to capture wind that would otherwise merely deflect over the wind tower. Again, the orientation of the vents 504 in the tower 500 allows the wind wall to collect a large amount of wind and funnel it into the turbines 556 while the vents 504 block the wind from the upper half of the turbines 556 and guide airflow into the lower half of the turbines 556 at the optimal angle.

In the illustrated embodiment, tower 500 includes one or more elevators 532 mounted on the outside generator towers 514. Handrails 534 can be welded or otherwise secured to the generator towers 514. Strobe lights or other tall structure alert mechanisms 536 can be mounted on one or more hoists 538. Hoists 538 in the present embodiment are mounted on top of the generator towers 514. Hoists 538 can extend past the stairs 552 and walkways 554 and can swivel to raise and lower parts to either side of the generator tower on which they are mounted. Hoists 538 can be operated by plugging a controller into a receptacle in one of the generator bays 516 below the hoist 538.

Generator towers 514 support the wind tower structure 500, vents 504, walkways 554, elevators 532, stairs 552 and house the generator bays 516. Upper guidelines 540 prevent the top of the wind tower 500 from over swaying in heavy winds. Lower guidelines 544 are mounted half way up the generator towers 514 to prevent them from buckling in high winds. In one embodiment, guidelines 540, 544 at the front of the wind towers 500 are attached to the front wind tower frame while the guidelines 540, 544 at the rear are attached to the stair frame. In certain embodiments, guidelines 540, 544 attach to offsetting anchors to prevent the wind tower 500 from twisting in high winds.

Base 546 in this embodiment is a solid cement foundation that is larger than the area of the wind tower to prevent settling. The base's 546 depth is determined by soil density, bedrock, water table depth, or other factors that may affect foundation integrity. Guide line anchors 548 are steel rods cemented into the ground with a loop protruding above ground level to which the guide lines 540, 544 are attached. The guideline anchor 548 depth is determined by the same conditions as the base 546 depth.

Base 546 is typically larger than the wind tower's footprint to support the weight of the structure. It is tapered upward to guide the ground wind into the bottom row of turbines.

In one embodiment, stairs 552 begin at ground level and go all the way to the top of the wind tower 500 with landings that join the walkways at every level. Walkways can be attached to the generator towers 514 and extend the width of the wind tower 500.

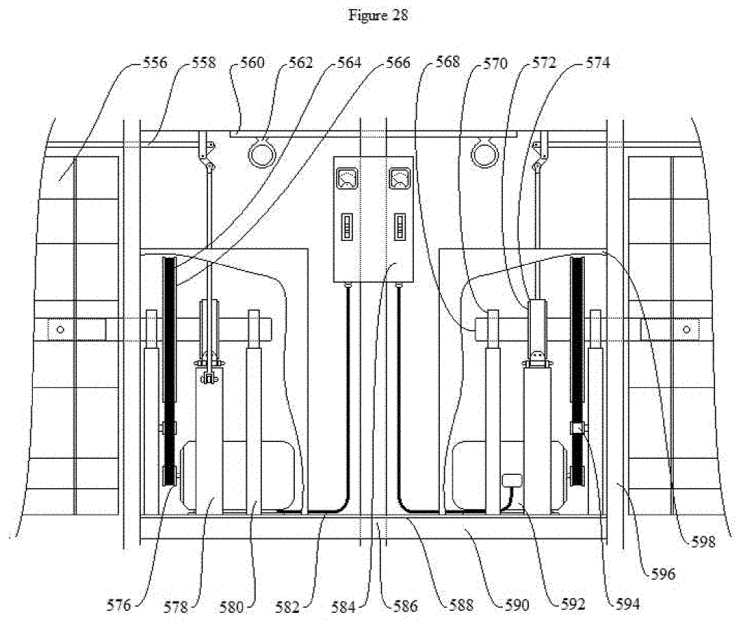

FIG. 28 illustrates the interior view of a generator bay 542 according to one embodiment of the present invention. As noted previously in connection with other embodiments, the generator bays 542 protect the generators, pulleys, belts, and electrical components from weather damage.

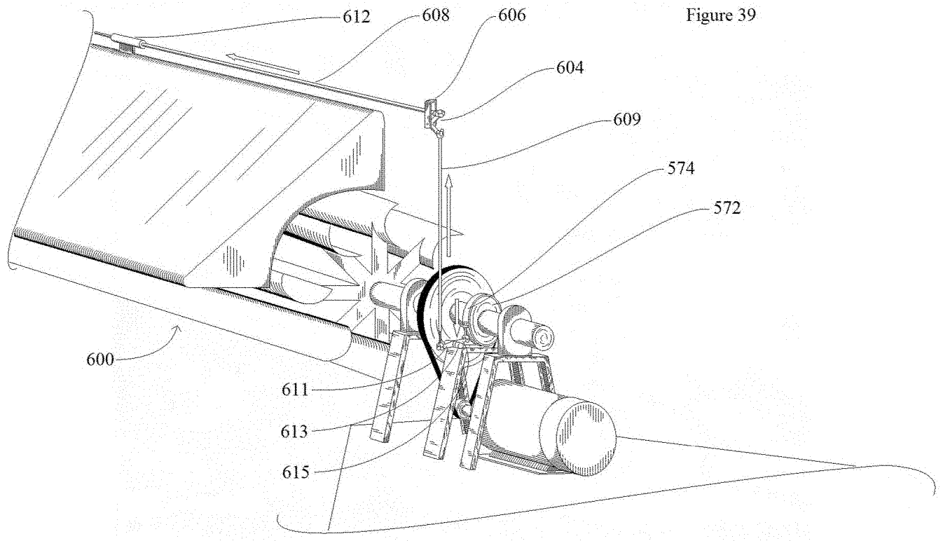

In the illustrated embodiment, turbine assembly 556 rotates in the wind. Brake linkage 558, as further illustrated in FIG. 39, sets and releases the brakes according to the position of the actuator 612. Hoist rail 560 allows the lifting eye 562 to slide. Lifting eye 562 connects to a hoist that is used to position a generator 592. Drive belt 564 connects the drive pulley 566 to the generator pulley 576. Drive pulley 566 is connected to a stub shaft 568. Stub shaft 568 is supported by carrier bearings 570 and is connected to the turbine 556 and drive pulley 566. Carrier bearings 570 are held in place by the carrier bearing pedestals 580. Brake drum 572 is connected to the stub shaft 568. Brake band 574 surrounds the brake drum 572. Generator pulley 576 is connected to the generator shaft. The generator pulley 576 is smaller than the drive pulley 566 so the generator shaft rotates faster than the turbines 556. Brake band pedestal 578 supports the brake band 574 and brake linkage 558. Carrier bearing pedestal 580 supports the weight of the carrier bearings 570, stub shafts 568, and turbines 556. Conduit 582 protects the wires that run from the generators 592 to the breaker panels 584. Breaker panels 584 meter the generator 592 output. They are equipped with a manual disconnect, and a breaker fuse to prevent overcharging. The breaker panels 584 connect to a bus cable. Bus conduit 586 houses the power cables from the generators 592 in each generator tower 514 to the bus breakers. Floor decking 588 serves as a floor, and a ceiling for the generator bay 516 below. Floor joists 590 support the weight of the generators 592 and pedestals 578, 580 and form the diamond shape of the generator towers 514. Generator 592 creates electricity when the generator shaft is rotated. Idler pulley 594 maintains tension on the drive belt 564 to prevent the belt slipping on the drive and generator pulleys 566, 576. Side structural supports 596 help support the weight of the generator towers 514. Belt guard 598 covers the stub shaft 568, pulleys 566, 576, brake assembly and generator 592 for safety. It can be removed to access such parts.

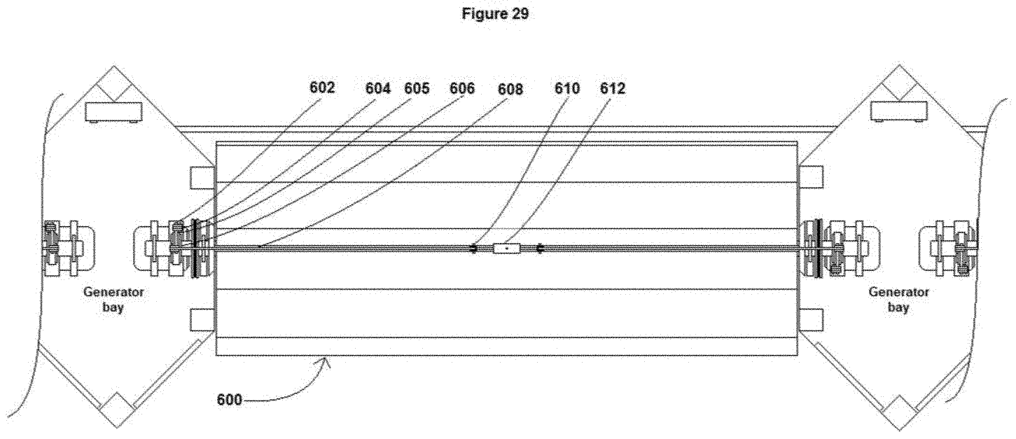

When stopping the rotation of a single turbine 556, two brakes must be set simultaneously on both sides of the turbine 556 to prevent the turbine 556 from twisting. Referring now to FIGS. 29 and 39, a brake linkage system 600 is shown according to certain embodiments of the present invention. In the braking system of FIG. 29, the linkage system 600 comprises one or more torque pins 602 having splines that mesh with grooves in V-links 604 to prevent them from slipping when the pin 602 rotates. The V-links 604 redirect the pushing or pulling action of the actuator 612 by ninety degrees. V-link pins 605 slide through the V-links 604 and link mounts 606 to allow the V-links 604 to rotate. Link mounts 606 are, in the illustrated embodiment, welded or otherwise secured on the generator bay 516 ceiling and brake band pedestal 578 to hold the V-links 604 in position. Push-pull rods 608 transfer the action of the actuator 612 to the brake band 574. Each rod can include an adjustment bolt and set nut at one end (not shown) to match the tension on both brakes. The push-pull rod to actuator linkage 610 attaches the top push pull rod 608 to the actuator 612 with a pin. The double push pull actuator 612 is, in one embodiment, an electric screw jack that extends and contracts two opposing rams equilaterally.

Referring more specifically to FIG. 39, to set the brakes, one would engage the double push-pull actuator 612 via an electric switch, this will pull both top push pull rods 608 toward the actuator 612. This pulls the upper half of the V-link 604 toward the actuator 612. The V-link 604 is mounted and can swivel on a pin in the V-link mounting bracket 606. When the upper half of the V-link 604 is pulled back the lower half of the V-link 604 is pulled upward, which in turn pulls the lower push-pull rod 609 up. Pulling the lower push-pull rod 609 up pulls the outer brake arm 611 upward. The brake arm 611 is mounted to the brake arm hinge 613 which is mounted to the brake pedestal. When the outer brake arm 611 is pulled the inner brake arm 615 is forced downward. The inner brake arm 615 is connected to the brake band 574 via a brake linkage so when the inner brake arm 615 is pulled downward the brake band 574 is forced to constrict around the brake drum 572. The friction between the brake band 574 and brake drum 572 stops the rotation of the turbine 556. Every action described above occurs on both sides of the turbine 556 simultaneously.

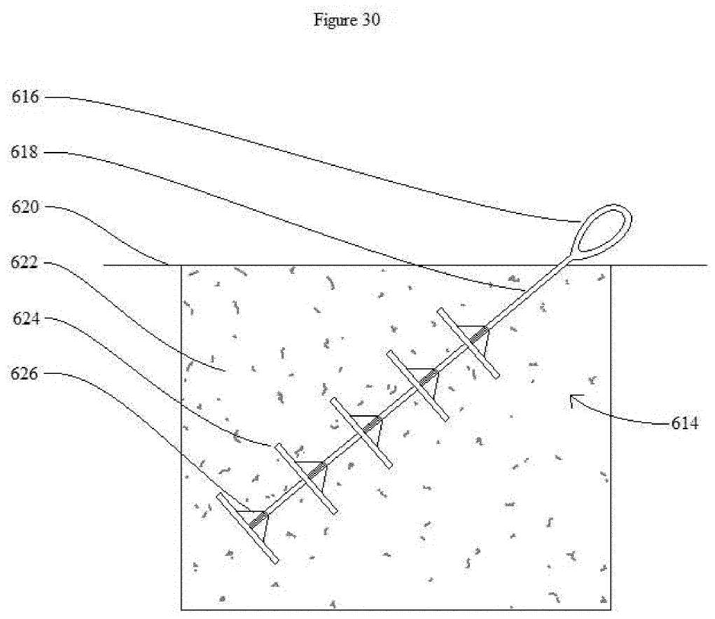

Referring to FIG. 30, an anchor 614 is depicted according to one embodiment of the present invention. In the illustrated embodiment, eyelet 616 is an extension of the shaft 618 that has been bent into a loop and welded back on itself. Guidelines 540, 544 as discussed herein previously can be attached to the eyelet 616. Shaft 618 can be a heavy steel rod. Element 620 illustrates the ground level in relation to the cement pad 622 and eyelet 616. Cement pad 622 in the illustrated embodiment encases the anchor 614 in the ground to provide solid support for the wind tower 500. Plates 624 are made of thick steel and are welded or otherwise secured to the shaft 618. The plates 624 prevent the anchor 614 from being pulled out of the cement pad 622. Gussets 626 can be welded or otherwise secured to the plates 624 and the shaft 618 for added strength.

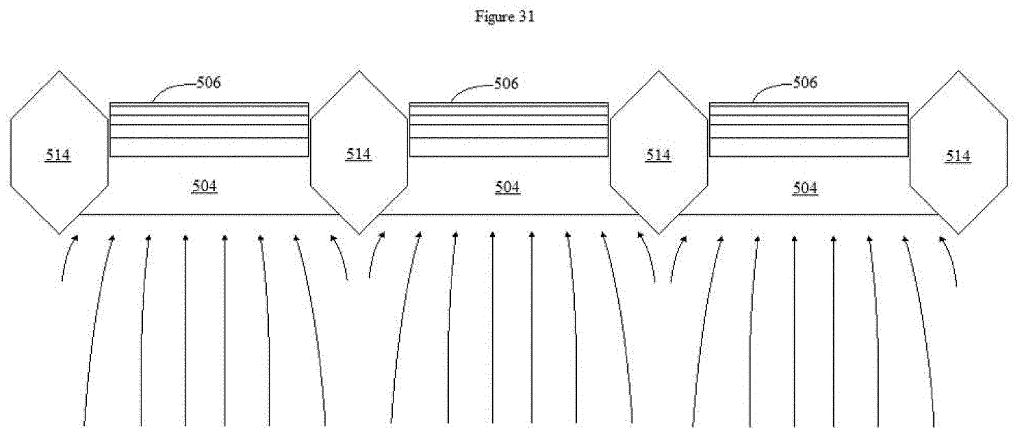

Referring to FIG. 31, wind induction based on the configuration of multi-column vent 504 stacks is shown. Generator towers 514 are shown having a diamond shape. Airflow is depicted by arrows directed into vent 504 and through turbine 556. As described previously, wind induction illustrates how the wind is directed by the vents 504 into the turbines 556 creating a high pressure area at the front of the wind tower 500 and a low pressure area behind the wind tower 500 thus drawing air though the turbines 556 at a higher speed than the surrounding wind speed making them more efficient.

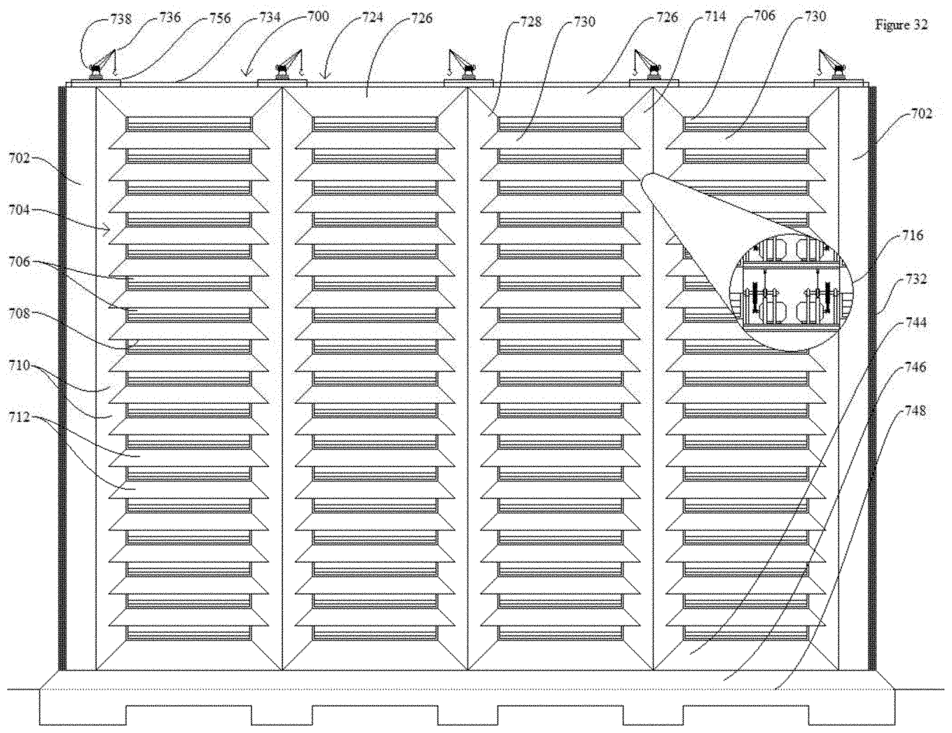

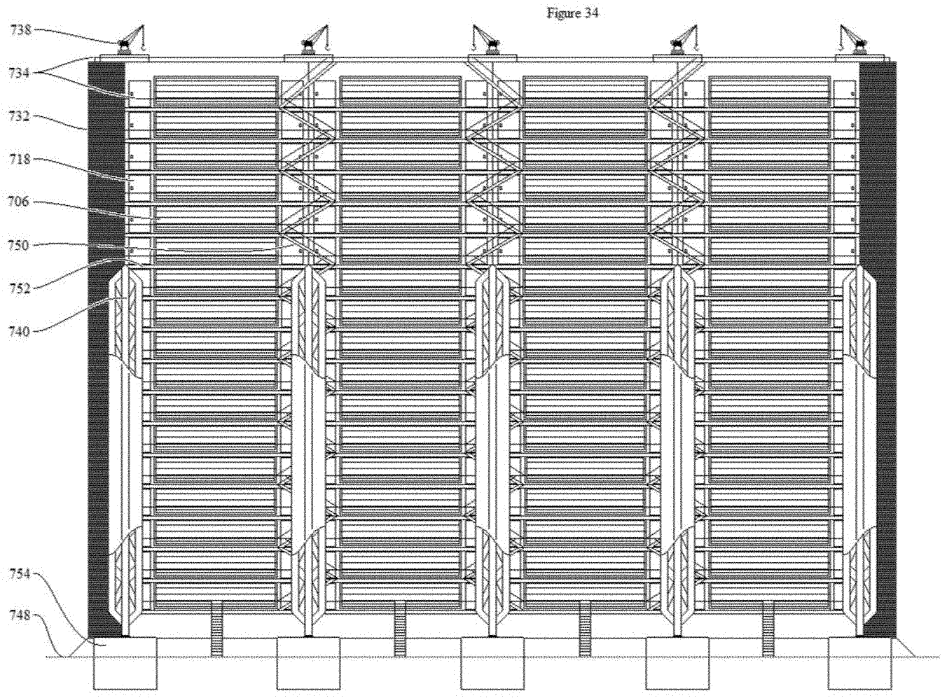

Referring now to FIGS. 32-34, wind tower 700 is shown according to yet another embodiment of the present invention. Wind tower 700 in this embodiment is multiple columns of vents 704. Each vent 704 corresponds to a turbine 706 and serves to direct wind currents toward the turbine 706. In certain embodiments, the turbines 706, illustrated in FIG. 5, will have eight blades. In other embodiments, the turbines 706 will have fewer or more blades. In one embodiment, the turbines 706 have up to twelve blades.

Vents 704 include a top wall 708, two sloped sidewalls 710 and a sloped bottom wall 712. These surfaces 708, 710, 712 all serve to capture the wind and direct it more effectively toward the turbines 706. Sidewalls 710 in the vents 704 are again typically external walls of the generator towers 714.

Each vent 704 and turbine 706 is associated with two generator towers 714 made up of a plurality of generator bays 716. The generator tower's 714 diamond shape funnels the wind into the turbines 706 and reduces the wind resistance of the tower. Each generator bay 716 can be accessed by a door 718. In certain embodiments, each generator bay 716 has two doors 718 (one for each generator). The generator bays 716 are in communication with the turbine 706 and house the components necessary to convert the wind energy into electrical energy.

Each stack of vents 704 can include a cap vent 724 having a top wall 726, two sidewalls 728 and a bottom wall 730. Again, these walls 726, 728, 730 function largely the same as walls 708, 710, 712 discussed above. However, in the cap vent 724, the top wall 726 has an angular orientation that allows it to capture wind that would otherwise merely deflect over the wind tower. Again, the orientation of the vents 704 in the tower 700 allows the wind wall to collect a large amount of wind and funnel it into the turbines 706 while the vents 704 block the wind from the upper half of the turbines 706 and guide airflow into the lower half of the turbines 706 at the optimal angle.

In the illustrated embodiment, tower 700 includes one or more elevators 732 mounted on the outside generator towers 714. Hand rails 734 can be welded or otherwise secured to the generator towers 714. The generator towers 714 support the wind tower structure 700, vents 704 walkways 752, elevators 732, stairs 750, and house the generator bays 716. Strobe lights or other tall structure alert mechanisms 736 can be mounted on one or more hoists 738. Hoists 738 in the present embodiment are mounted on top of the generator towers 714. Hoists 738 can extend past the stairs 750 and walkways 752 and can swivel to raise and lower parts to either side of the generator tower on which they are mounted. Hoists 738 can be operated by plugging a controller into a receptacle in one of the generator bays 716 below the hoist 738. Again, in the illustrated embodiment, the cement foundation 746 is larger than the wind tower's 700 footprint to support the weight of the structure. It is tapered upward to guide the ground wind into the bottom row 744 of turbines 706.

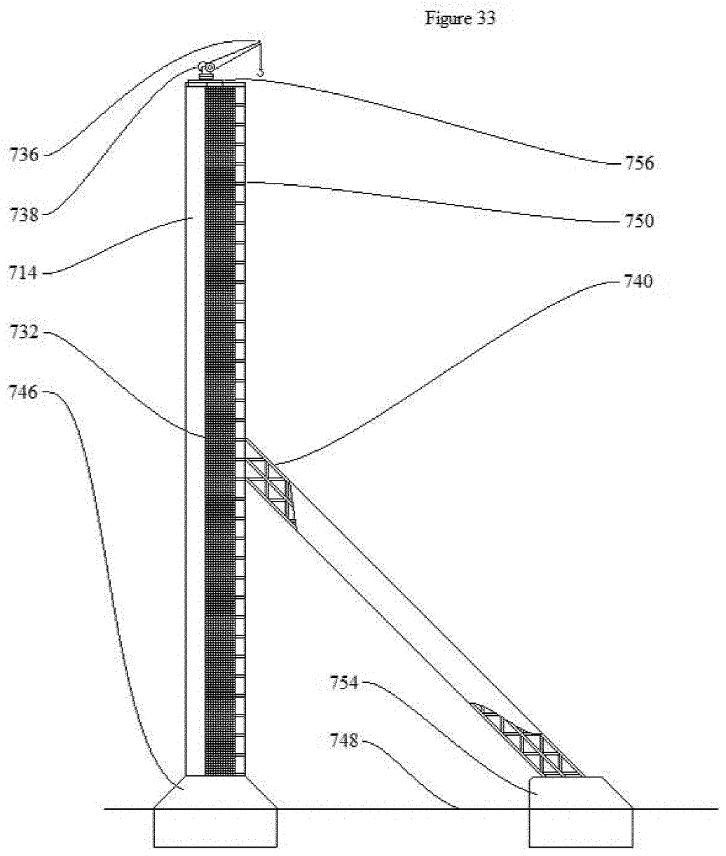

Diagonal braces 740 can be included to reduce swaying caused by wind pressure near the middle of the generator towers. The diagonal brace foundations 754 house the anchor suspensions that prevent the diagonal braces 740 from buckling under excessive pressure. FIG. 33 illustrates the portion of the foundation 746 that is below ground level 748. Sway dampers 756, discussed further below, can also be included to reduce the effects of wind pressure causing the towers 700 to sway.

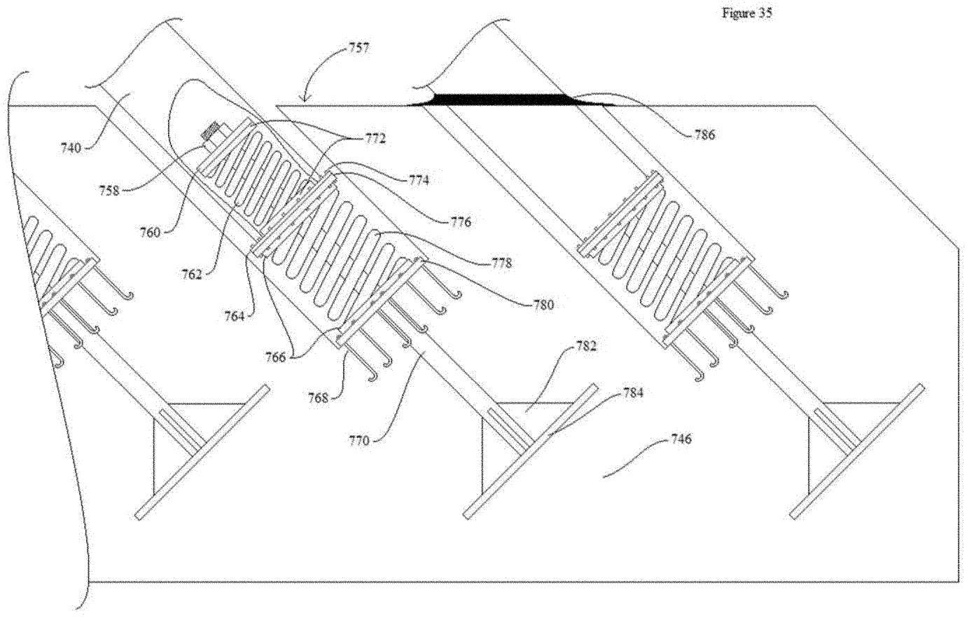

Referring to FIG. 35, an anchor system 757 for a diagonal brace 740 is shown according to one embodiment of the present invention. The anchor suspension is connected to the three main tubes that make up each diagonal brace 740. The anchor suspension 757 uses a compression spring 778 to absorb the swaying effects from wind buffeting the center of the wind tower 700, while the recoil spring 762 reduces back and forth swaying. Diagonal brace 740 can be attached to the generator tower 700 on three levels. Tension nut 758 is screwed onto the guide bolt 770 to keep tension on the springs 762, 778. Top pressure plate 760 holds even pressure on the recoil spring 762. Recoil spring 762 is smaller and weaker than the compression spring 778 because more force is exerted on the front of the wind tower so more force is exerted on the compression spring 778. Each diagonal brace flange 764 is welded to a diagonal brace tube and bolted to the middle pressure plate 776. Compression spring retainer rings 766 center the compression spring 778 on the pressure plates 776, 780.

Bottom pressure plate anchor bolts 768 are embedded in the cement foundation 746 to hold the bottom pressure plate 780 in place. Guide bolt 770 is embedded in the cement foundation 746 and keeps the springs compressed slightly. Recoil spring retainer rings 772 center the recoil spring 762 on the pressure plates 760, 776. Diagonal brace flange bolts 774 connect the diagonal brace tubes to the middle pressure plate 776. Middle pressure plate 776 is attached to the bottom recoil spring retainer ring 772 and the top compression spring retainer ring 766. Compression spring 778 compresses when the generator tower 714 is pressed back by the wind. Bottom pressure plate 780 is attached to the bottom compression spring retainer ring 766 and is attached to the cement foundation 746 by the anchor bolts 768. Anchor plate gussets 782 are welded to the anchor plate 784 and guide bolt 770 for added strength. Anchor plate 784 prevents the guide bolt 770 from penetrating deeper or pulling out of the cement foundation 746. Cement foundation 746 is partially submerged below ground level to provide a solid base for the diagonal brace suspension. Rubber boots 786 seal to the diagonal brace tubes and cement foundation 746 to keep moisture away from the suspension components.

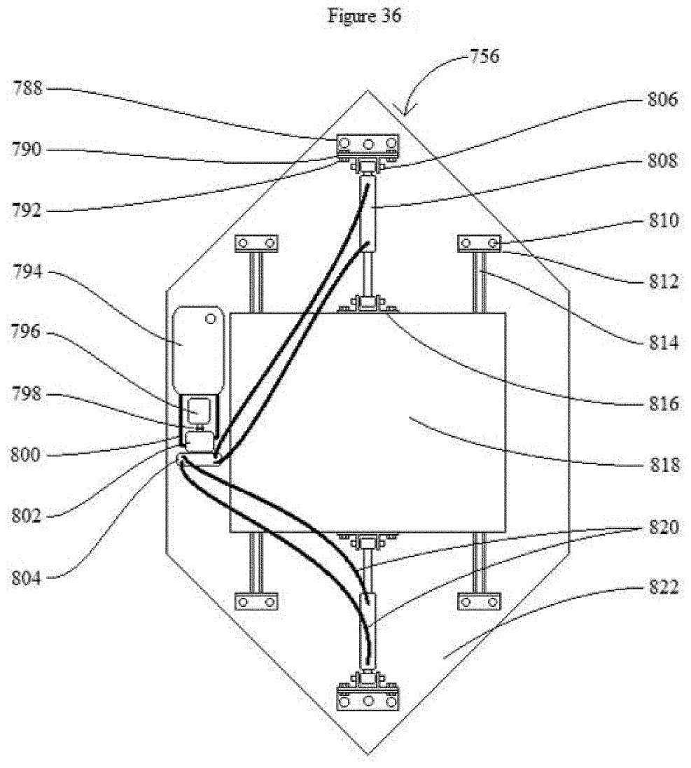

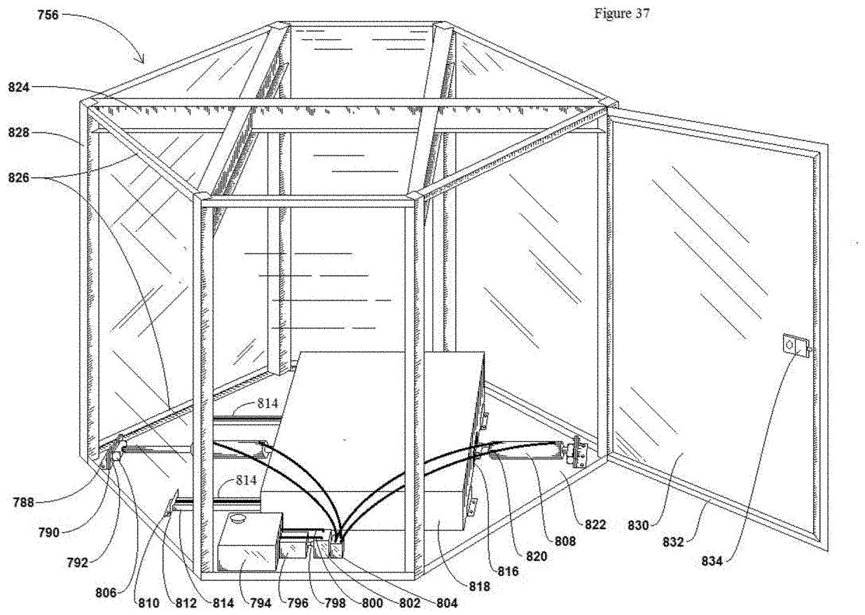

Referring now to FIGS. 36 and 37, a sway damper 756 is shown according to one embodiment of the present invention. Notably, as seen herein, in certain embodiments, the present invention is made up of multiple generator towers. Each generator tower can have a sway damper 756 on the top level. Specific reference is made to generator tower 714. However, the application of sway dampers is not intended to be limited to the embodiments specifically described but rather to all generator towers as discussed herein and as may be applicable. Similarly, all features of the present invention described with reference to particular embodiments are not intended to be limited to application with those specific embodiments. Rather, general principles are intended to be illustrated, which can be combined in multiple ways—some specifically described herein, and some not.

Again, referring to FIGS. 36 and 37, sway dampers 756 in the illustrated embodiment need only mitigate front to back movement caused by wind buffeting. In particular, the presently illustrated wind tower has multiple generator towers 714 that are attached parallel to each other by walkways 752. This interconnectivity largely prevents side-to-side movement. Thus, dampening is only needed in the front/back direction.

Damper 756 in this embodiment includes ram mounts 790 and ram to roof mounts 788. Ram to roof mounts 788 are bolted 792 or otherwise secured to a roof plate. Hydraulic reservoir 794 contains the hydraulic fluid to operate the hydraulic systems. Electric motor 796 rotates the hydraulic pump shaft. Shaft coupling 798 attaches the electric pump shaft to the hydraulic pump shaft. Supply and return hydraulic lines 800 keep a constant supply of hydraulic fluid to the hydraulic pump 802. Hydraulic pump 802 supplies high-pressure hydraulic fluid to the shuttle valve 804. Shuttle valve 804 is actuated when an electronic level switch is triggered by excessive swaying of the generator tower 714. This swaying sends a signal to the shuttle valve 804 to send hydraulic fluid to the rams to slide the counter weight 818. Hydraulic ram pins 806 attach the hydraulic rams 808 to the ram mounts. Hydraulic rams 808 work in unison to push one side of the counter weight 818 while pulling the other side at the same time. Stop bracket bolts 810 attach the stop brackets 812 to the roof plate. Stop brackets 812 prevent the counter weight 818 from sliding off the guide track 814. In this embodiment, guide track is a roller bearing guide track. Guide track 814 keeps the roller bearings aligned so the counter weight 818 can roll with the least amount of resistance. Ram to counter weight mounts 816 attach the hydraulic rams 808 to the counter weight 818. Counter weight 818 can be various materials alone or in combination including, but not limited to, a single block of steel, cement, or a stack of steel plates. Hydraulic hoses 820 supply high-pressure hydraulic fluid from the shuttle valve 804 to the rams 808.

An example of a sway damper bay is shown at 822. The bay 822 features an I beam roof frame 824 with angle iron trim 826 to which siding can be mounted. Wall frame 828 is in the illustrated embodiment made of square tubing 828. Bay 822 can include a door 830 fitted to a door frame 832. Frame 832 in the illustrated embodiment is made of angle irons. Door can also include a locking mechanism 834 which in the illustrated embodiment is a latch.

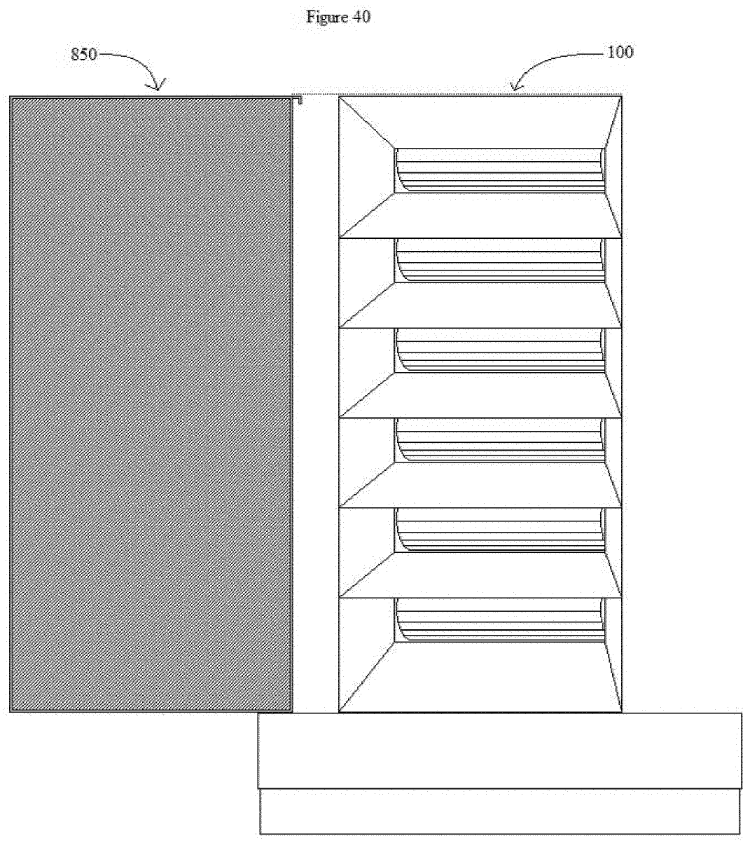

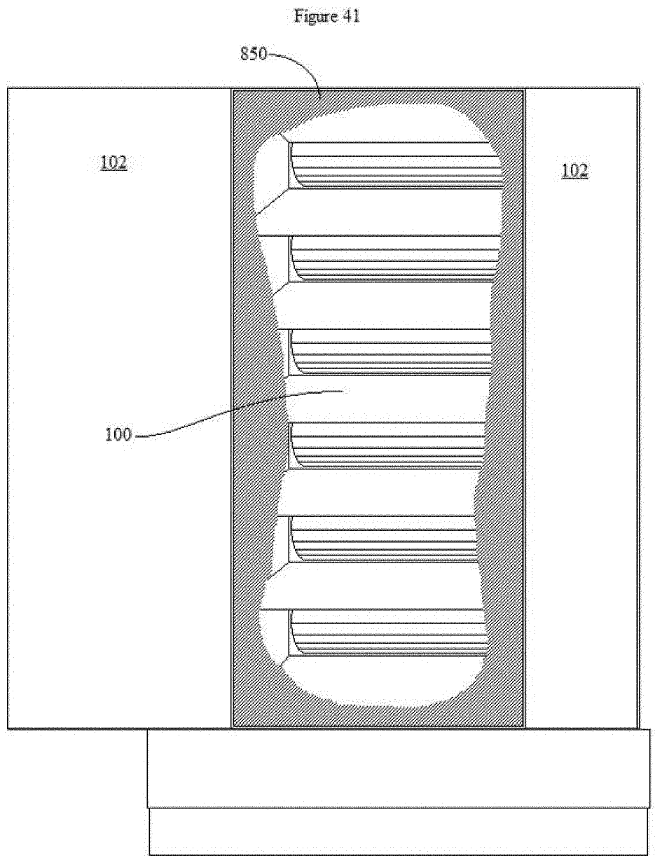

Referring to FIGS. 40 and 41, a front view of a wind-powered electrical generation system is shown according to one embodiment of the present invention. This embodiment includes a safety screen 850 that keeps flying animals and other airborne objects such as drones out of the turbines.

1) A wind-powered electrical generation system comprising:
a) a base;
b) a first generator tower atop the base having a first generator bay and a second generator tower atop the base having a second generator bay;
c) a wind tower atop the base, comprising a vent having top wall, a bottom wall, a first sloped side wall, a second sloped side wall and a back opening, wherein the first sloped side wall is contributed by the first generator tower and the second side wall is contributed by the second generator tower;
d) a turbine positioned proximate to the back opening of the vent and in mechanical communication with a first electrical generator and a second electrical generator, wherein the first electrical generator is located inside the first generator bay and the second electrical generator is located inside the second generator bay;
e) a first wind wall adjacent to the first sloped side wall of the vent; and
f) a second wind wall adjacent to the second sloped side wall of the vent.

2) The wind-powered electrical generation system of claim 1, further comprising a cap vent having a cap vent top wall, a first cap vent sloped side wall, a second cap vent sloped side wall and a cap vent bottom wall.

3) The wind-powered electrical generation system of claim 2, wherein the cap vent top wall has a downward angular orientation.

4) The wind-powered electrical generation system of claim 2, further including a first cap vent wind wall having a coupled to the cap vent.

5) The wind-powered electrical generation system of claim 1 wherein the base further comprises an inner base and an outer base.

6) The wind-powered electrical generation system of claim 5, wherein the inner base further comprises:
a) a cement pad;
b) a first base beam coupled to the cement pad;
c) a second base beam coupled to the cement pad;
d) an upward oriented shaft positioned substantially at a central intersection point between the first base beam and the second base beam;
e) an upper side beam pivotally connected to the upward oriented shaft and above the first and second base beams;
f) an upper front beam pivotally connected to the upward oriented shaft and above the first and second base beams;
g) a first hydraulic ram connecting a first side of the upper side beam to the first base beam;
h) a second hydraulic ram connecting a second side of the upper side beam to the first base beam;
i) rollers on a first end of the side beams;
j) rollers on the second end of side beams; and
k) rollers on the front beam, wherein actuation of the first and second hydraulic rams causes the upper side beam to rotationally move relative to the center shaft.

7) The wind-powered electrical generation system of claim 6, further comprising an upper back beam coupled to the upper front beam.

8) The wind-powered electrical generation system of claim 6, wherein the upper side beam includes a horizontal side beam component and a vertical side beam component.

9) The wind-powered electrical generation system of claim 6, wherein the upper front beam includes a horizontal front beam and a vertical front beam.

10) The wind-powered electrical generation system of claim 7, wherein the upper back beam includes a horizontal back beam and a vertical back beam.

11) The wind-powered electrical generation system of claim 5, further comprising one or more rollers under the first and the second wind walls and wherein the rollers roll on the outer base.

12) The wind-powered electrical generation system of claim 11, wherein the outer base includes a beam track whereon the rollers roll.

13) The wind-powered electrical generation system of claim 1, wherein the wind tower is a single column of vents.

14) The wind-powered electrical generation system of claim 1, wherein the wind tower is multiple columns of vents.

15) The wind-powered electrical generation system of claim 1, wherein the turbine includes one or more blades mounted to corresponding spokes.

16) The wind-powered electrical generation system of claim 1, wherein the first and second generator bays are substantially diagonally shaped.

17) The wind-powered electrical generation system of claim 1, wherein the first generator bay is in electrical communication with a third generator bay stacked above the first generator bay and the second generator bay is in electrical communication with a fourth generator bay stacked above the second generator bay.

18) The wind-powered electrical generation system of claim 1, further comprising one or more detachable braces attached to the generator tower.

19) The wind-powered electrical generation system of claim 1, further including a turtle deck substantially covering the base.

20) An electrical generation system powered by a wind comprising:
a) a base;
b) a first generator tower above the base having a first generator bay and a second generator tower above the base having a second generator bay;
c) a wind tower above the base, comprising a vent having top wall, a sloped bottom wall, a first sloped side wall, a second sloped side wall and a back opening;
d) a turbine positioned proximate to the back opening of the vent, wherein the vent creates a pressure differential across the turbine, and wherein the turbine is in mechanical communication with a first electrical generator and a second electrical generator, wherein the first electrical generator is located inside the first generator bay and the second electrical generator is located inside the second generator bay;
e) a first wind wall adjacent to the first sloped side wall of the vent; and
f) a second wind wall adjacent to the second sloped side wall of the vent.
